(19) United States
(12) Patent Application Publication
(10) Pub. No.: US 2010/0317517 A1
(43) Pub. Date: Dec. 16, 2010

(54) HERBICIDE-SAFENER COMBINATION

(75) Inventors: Chris Hugh Rosinger, Hofheim (DE); Erwin Hacker, Hochheim (DE); Georg Bonfig-Picard, Rodenbach (DE); Dominique Schreiber, Frankfurt (DE); Christian Waldraff, Bad Vilbel (DE); Klaus-Helmut Mueller, Duesseldorf (DE); Ernst Rudolf Gesing, Ekrath-Hochdahl (DE)

Correspondence Address: Baker Donelson Bearman, Caldwell & Berkowitz, PC, 920 Massachusetts Ave, NW, Suite 900, Washington, DC, 20001, US

(73) Assignee: BAYER CROPSCIENCE AG, Monheim (DE)

(21) Appl. No.: 12/739,364

(22) PCT Filed: Oct. 22, 2008
(86) PCT No.: PCT/EP2008/008927

§ 371 Date: May 28, 2010

(30) Foreign Application Priority Data
Oct. 24, 2007 (EP) 07020859.0

(51) Int. Cl. A01N 25/32

(52) U.S. Cl. 504/107; 504/103; 504/112

(57) ABSTRACT

The present invention relates to a herbicide/safener combination comprising:
(A) one or more herbicides from the group consisting of 2-iodo-N-[(4-methoxy-6-methyl-1,3,5-triazin-2-yl)carbamoyl]benzenesulfonamide and compounds of the general formula (I)

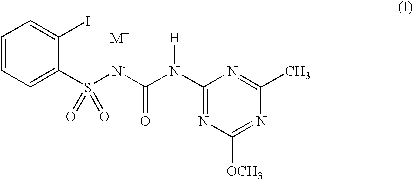

and (B) one or more safeners, and to their use for controlling harmful plants.

The invention relates to the technical field of the crop protection compositions, in particular herbicide/safener combinations, which are highly suitable for use against harmful plants in crops of useful plants.

It is known that certain N-(1,3,5-triazin-2-yl-aminocarbonyl)arylsulfonamides have herbicidal properties (cf. DE 27 15 786). From WO 2006/114220, it is furthermore known that sulfonamides iodinated at the phenyl ring have herbicidal properties.

However, some of these active compounds are not fully compatible with a number of important crop plants, such as, for example, various cereal species (such as wheat, triticale, barley, rye), sugar cane, sugar beet, soybeans, oilseed rape, corn, rice or cotton. Accordingly, in some crops, they cannot be employed in a manner which ensures the desired broad herbicidal activity against harmful plants.

It was an object of the present invention to provide herbicidal compositions in which the selectivity of the herbicides mentioned above with a view to important crop plants is increased. Surprisingly, this object is achieved by the herbicide/safener combination of the present invention.

Accordingly, the present invention provides a herbicide/safener combination comprising
(A) one or more herbicides from the group consisting of 2-iodo-N-[(4-methoxy-6-methyl-1,3,5-triazin-2-yl)carbamoyl]benzenesulfonamide and compounds of the general formula (I)

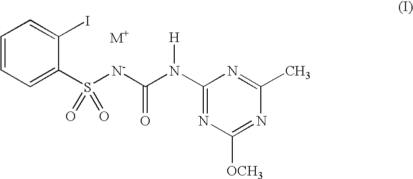

where
the cation (M⁺) is
   (a) an alkali metal ion, preferably lithium, sodium, potassium, or
   (b) an alkaline earth metal ion, preferably calcium or magnesium, or
   (c) a transition metal ion, preferably manganese, copper, zinc or iron, or
   (d) an ammonium ion where optionally one, two or three or all four hydrogen atoms are substituted by identical or different radicals from the group consisting of (C₁-C₄)-alkyl, hydroxy-(C₁-C₄)-alkyl, (C₃-C₆)-cycloalkyl, (C₁-C₄)-alkoxy-(C₁-C₄)-alkyl, hydroxy-(C₁-C₄)-alkoxy-(C₁-C₄)-alkyl, (C₁-C₆)-mercaptoalkyl, phenyl and benzyl, where the radicals mentioned above are optionally substituted by one or more identical or different radicals from the group consisting of halogen, such as F, Cl, Br or I, nitro, cyano, azido, (C₁-C₆)-alkyl, (C₁-C₆)-haloalkyl, (C₃-C₆)-cycloalkyl, (C₁-C₆)-alkoxy, (C₁-C₆)-haloalkoxy and phenyl and where in each case two substituents at the nitrogen atom together optionally form an unsubstituted or substituted ring, or
   (e) a phosphonium ion, or
   (f) a sulfonium ion, preferably tri((C₁-C₄)-alkyl)sulfonium, or
   (g) an oxonium ion, preferably tri((C₁-C₄)-alkyl)oxonium, or
   (h) a saturated or unsaturated/aromatic nitrogenous heterocyclic ionic compound which has 1-10 carbon atoms in the ring system and is optionally mono- or polycondensed and/or substituted by (C₁-C₄)-alkyl, and
(B) one or more safeners.

Additionally, the herbicide/safener combinations according to the invention may comprise further components, for example crop protection agents of a different type and/or formulation auxiliaries and/or additives customary in crop protection, or may be used together with these.

The herbicides (A) and the safeners (B) can be applied in a known manner, for example together (for example as a coformulation or as a tank mix) or else at different times (splitting), for example to the plants, plant parts, plant seeds, seed treatment or the area where the plants grow. It is possible, for example, to apply the individual active compounds or the herbicide/safener combination in a plurality of portions (sequential application), for example seed treatment followed by pre-emergence and/or post-emergence application, or pre-emergence applications followed by post-emergence applications or early post-emergence applications followed by medium or late post-emergence applications. Preference is given here to the joint or almost simultaneous application of the active compounds of the combination in question. It is also possible to use the individual active compounds or the herbicide/safener combination for treating seed.

The formula (I) mentioned embraces all stereoisomers and their mixtures, in particular also racemic mixtures, and—if enantiomers are possible—the respective enantiomer which is biologically active.

Preferred herbicides (A) are 2-iodo-N-[(4-methoxy-6-methyl-1,3,5-triazin-2-yl)carbamoyl]benzenesulfonamide and compounds of the formula (I) in which the cation (M⁺) is
(a) an alkali metal on, preferably lithium, sodium, potassium, or
(b) an alkaline earth metal ion, preferably calcium or magnesium, or
(c) a transition metal ion, preferably manganese, copper, zinc or iron, or
(d) an ammonium ion where optionally one, two, three or all four hydrogen atoms are substituted by identical or different radicals from the group consisting of (C₁-C₄)-alkyl, hydroxy-(C₁-C₄)-alkyl, (C₃-C₄)-cycloalkyl, (C₁-C₂)-alkoxy-(C₁-C₂)-alkyl, hydroxy-(C₁-C₂)-alkoxy-(C₁-C₂)-alkyl, (C₁-C₂)-mercaptoalkyl, phenyl and benzyl, where the radicals mentioned above are optionally substituted by one or more identical or different radicals from the group consisting of halogen, such as F, CI, Br or I, nitro, cyano, azido, (C₁-C₂)-alkyl, (C₁-C₂)-haloalkyl, (C₃-C₄)-cycloalkyl, (C₁-C₂)-alkoxy, (C₁-C₂)-haloalkoxy and phenyl, and where in each case two substituents at the nitrogen atom together optionally form an unsubstituted or substituted ring, or
(e) a quaternary phosphonium ion, preferably tetra-((C₁-C₄)-alkyl)phosphonium and tetraphenylphosphonium, where the (C₁-C₄)-alkyl radicals and the phenyl radicals are optionally mono- or polysubstituted by identical or different radicals from the group consisting of halogen, such as F, CI, Br or I, (C₁-C₂)-alkyl, (C₁-C₂)-haloalkyl, (C₃-C₄)-cycloalkyl, (C₁-C₂)-alkoxy, (C₁-C₂)-haloalkoxy, or
(f) a tertiary sulfonium ion, preferably tri((C₁-C₄)-alkyl)sulfonium or triphenylsulfonium, where the (C₁-C₄)-alkyl radicals and the phenyl radicals are optionally mono- or polysubstituted by identical or different radicals from the group consisting of halogen, such as F, Cl, Br or I, (C₁-C₂)-alkyl, (C₁-C₂)-haloalkyl, (C₃-C₄)-cycloalkyl, (C₁-C₂)-alkoxy, (C₁-C₂)-haloalkoxy, or
(g) a tertiary oxonium ion, preferably tri((C₁-C₄)-alkyl)oxonium, where the (C₁-C₄)-alkyl radicals are optionally mono- or polysubstituted by identical or different radicals from the group consisting of halogen, such as F, Cl, Br or I, (C₁-C₂)-alkyl, (C₁-C₂)-haloalkyl, (C₃-C₄)-cycloalkyl, (C₁-C₂)-alkoxy, (C₁-C₂)-haloalkoxy, or
(h) a cation from the group of the following heterocyclic compounds, such as, for example, pyridine, quinoline, 2-methylpyridine, 3-methylpyridine, 4-methylpyridine, 2,4-dimethylpyridine, 2,5-dimethylpyridine, 2,6-dimethylpyridine, 5-ethyl-2-methylpyridine, piperidine, pyrrolidine, morpholine, thiomorpholine, pyrrole, imidazole, 1,5-diazabicyclo[4.3.0]non-5-ene (DBN), 1,8-diazabicyclo[5.4.0]undec-7-ene (DBU).

The hydrocarbon radicals mentioned in the radical definitions, such as alkyl, alkenyl or alkynyl, also in combinations with heteroatoms, such as an alkoxy, alkylthio, haloalkyl or alkylamino, are straight-chain or branched, even if this is not explicitly mentioned.

Examples of preferred compounds used as herbicide (A) are 2-iodo-N-[(4-methoxy-6-methyl-1,3,5-triazin-2-yl)carbamoyl]benzenesulfonamide (A-0) and the compounds of the formula (I) listed in table A below (i.e. the compounds (A-1 to A-35)).

TABLE A
Compounds of the general formula (I),
where M⁺denotes the respective salt of the compound
(I)

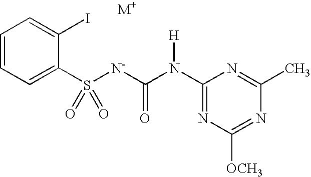

| Compound | M⁺ |
|---|---|
| A-1 | lithium |
| A-2 | sodium |
| A-3 | potassium |
| A-4 | magnesium |
| A-5 | calcium |
| A-6 | ammonium |
| A-7 | methylammonium |
| A-8 | dimethylammonium |
| A-9 | tetramethylammonium |
| A-10 | ethylammonium |
| A-11 | diethylammonium |
| A-12 | tetraethylammonium |
| A-13 | propylammonium |
| A-14 | tetrapropylammonium |
| A-15 | isopropylammonium |
| A-16 | diisopropylammonium |
| A-17 | butylammonium |
| A-18 | tetrabutylammonium |
| A-19 | (2-hydroxyeth-1-yl)ammonium |
| A-20 | bis-N,N-(2-hydroxyeth-1-yl)ammonium |
| A-21 | tris-N,N,N-(2-hydroxyeth-1-yl)ammonium |
| A-22 | 1-phenylethylammonium |
| A-23 | 2-phenylethylammonium |
| A-24 | trimethylsulfonium |
| A-25 | trimethyloxonium |
| A-26 | pyridinium |
| A-27 | 2-methylpyridinium |
| A-28 | 4-methylpyridinium |
| A-29 | 2,4-dimethylpyridinium |
| A-30 | 2,6-dimethylpyridinium |
| A-31 | piperidinium |
| A-32 | imidazolium |
| A-33 | morpholinium |
| A-34 | 1,5-diazabicyclo[4.3.0]non-7-enium |
| A-35 | 1,8-diazabicyclo[5.4.0]undec-7-enium |

Particularly preferred herbicides (A) are 2-iodo-N-[(4-methoxy-6-methyl-1,3,5-triazin-2-yl)carbamoyl]benzenesulfonamide and compounds of the formula (I) in which the cation (M⁺) is

a sodium ion, a potassium ion, a lithium ion, a magnesium ion, a calcium ion, an NH₄⁺ ion, a (2-hydroxyeth-1-yl)ammonium ion, a bis-N,N-(2-hydroxyeth-1-yl)ammonium ion, a tris-N,N,N-(2-hydroxyeth-1-yl)ammonium ion, a methylammonium ion, a dimethylammonium ion, a trimethylammonium ion, a tetramethylammonium ion, an ethylammonium ion, a diethylammonium ion, a triethylammonium ion, a tetraethylammonium ion, an isopropylammonium ion, a diisopropylammonium ion, a tetrapropylammonium ion, a tetrabutylammonium ion, a 2-(2-hydroxyeth-1-oxy)eth-1-ylammonium ion, a di(2-hydroxyeth-1-yl)ammonium ion, a trimethylbenzylammonium ion, a tri((C₁-C₄)-alkyl)sulfonium ion, or a tri((C₁-C₄)-alkyl)oxonium ion, a benzylammonium ion, a 1-phenylethylammonium ion, a 2-phenylethylammonium ion, a diisopropylethylammonium ion, a pyridinium ion, a piperidinium ion, an imidazolium ion, a morpholinium ion, a 1,8-diazabicyclo[5.4.0]undec-7-enium ion.

Particularly preferred herbicides (A) are 2-iodo-N-[(4-methoxy-6-methyl-1,3,5-triazin-2-yl)carbamoyl]benzenesulfonamide and compounds of the formula (I) in which the cation (M⁺) is a sodium ion, a potassium ion, a magnesium ion, a calcium ion or an NH₄⁺ ion.

Particularly preferred herbicides (A) are likewise 2-iodo-N-[(4-methoxy-6-methyl-1,3,5-triazin-2-yl)carbamoyl]benzenesulfonamide and compounds of the formula (I) in which the cation (M⁺), a sodium ion, a potassium ion or an NH₄ ion.

Depending on the type and the attachment of the substituents, the compounds of the formula (I) can be present as stereoisomers. The formula (I) embraces all possible stereoisomers defined by their specific spatial form, such as enantiomers, diastereomers, Z and E isomers.

If, for example, one or more alkenyl groups are present, diastereomers (Z and E isomers) may occur. If, for example, one or more asymmetrically substituted carbon atoms are present, enantiomers and diastereomers may occur. From the mixtures produced in the preparation, stereoisomers can be obtained by customary separation methods, for example by chromatographic separation procedures. Stereoisomers can also be prepared selectively by using stereoselective reactions and employing optically active starting materials and/or auxiliaries. Accordingly, the invention also relates to all stereoisomers embraced by the general formula (I) but no longer shown in their specific stereo form, and to their mixtures.

The preparation of salts of 2-iodo-N-[(4-methoxy-6-methyl-1,3,5-triazin-2-yl)carbamoyl]benzenesulfonamide, in particular of compounds of the general formula (I), is known from the prior art; cf. also the European patent application EP07020807.9, filed on Oct. 24, 2007, from Bayer CropScience AG having the title “Salts of 2-iodo-N-[(4-methoxy-6-methyl-1,3,5-triazin-2-yl)carbamoyl]benzenesulfonamide, processes for their preparation and their use as herbicides and plant growth regulators”.

The herbicides of group (A) inhibit the enzyme aceto lactate synthase (ALS) and thus protein biosynthesis in plants. The application rate of the herbicides (A) can vary within a wide range, for example between 0.001 g and 1500 g of AS/ha (hereinbelow, AS/ha means “active substance per hectare”=based on 100% pure active compound). Applied at application rates of from 0.001 g to 1500 g of AS/ha, the herbicides (A), preferably the compounds A-0 to A-35, control, when used by the pre- and post-emergence method a relatively wide spectrum of harmful plants, for example of annual and perennial mono- or dicotyledonous weeds, and also of unwanted crop plants. For the combinations according to the invention, the application rates are generally, for example, in the range of from 0.001 g to 1000 g of AS/ha, preferably from 0.1 g to 500 g of AS/ha, particularly preferably from 0.5 g to 250 g of AS/ha.

The herbicides (A) are suitable for controlling harmful plants, for example in crop plants, for example in economically important arable crops, for example monocotyledonous arable crops, such as cereals (for example wheat, barley, rye, oats), rice, corn, millet, or dicotyledonous arable crops, such as sugar cane, sugar beet, oilseed rape, cotton, sunflowers and leguminous plants, for example of the genera Glycine (for example Glycine max. (soybean), such as non-transgenic Glycine max. (for example conventional cultivars, such as STS cultivars) or transgenic Glycine max. (for example RR soybeans or LL soybeans) and crossbreeds thereof), Phaseolus, Pisum, Vicia and Arachis, or vegetable crops from various botanical groups, such as potato, leek, cabbage, carrot, tomato, onion, and also permanent crops and plantation crops, such as pomaceous fruit and stone fruit, soft fruit, grapevines, Hevea, bananas, sugar cane, coffee, tea, citrus plants, nut plantations, lawn, palm plantations and forest plantations. These crops are likewise preferred for the use of the herbicide/safener combinations (A)+(B) according to the invention; particular preference is given to the use in cereal (for example wheat, barley, rye, oats), rice, corn, millet, sugar beet, sugar cane, sunflowers, oilseed rape and cotton. The herbicide/safener combinations (A)+(B) can also be used in tolerant and non-tolerant mutant crops and in tolerant and non-tolerant transgenic crops, for example in corn, rice, cereal, oilseed rape and soybeans, for example those which are resistant to imidazolinone herbicides, atrazine, glufosinate or glyphosate.

The safeners comprised as component (B) are to be understood as compounds suitable for reducing phytotoxic actions of crop protection agents, such as herbicides, on crop plants.

Of particular interest is the selective control of harmful plants in crops of useful plants and ornamental plants. Although the herbicides (A) have already demonstrated very good to sufficient selectivity in a large number of crops, in principle, in some crops and in particular also in the case of mixtures with other, less selective herbicides, phytotoxicities on the crop plants may occur. In this respect, herbicides (A) comprising one or more safeners are of particular interest. The safeners, which are used in an antidotically effective amount, reduce the phytotoxic side effects of the herbicides/pesticides employed, for example in economically important crops, such as cereals (wheat, barley, rye, corn, rice, millet), sugar beet, sugar cane, oilseed rape, cotton and soybeans, preferably cereals.

Unless a different definition is given specifically, the definitions applying to the radicals of the formulae (S-I) to (S-XII) below are generally as follows:

In all formulae (S-I)-(S-XII) given below the radicals alkyl, alkoxy, haloalkyl, haloalkoxy, alkylamino, alkylthio, haloalkylthio, alkylsulfinyl, alkylsulfonyl, haloalkylsulfinyl, and haloalkylsulfonyl, and also the corresponding unsaturated and/or substituted radicals in the carbon skeleton, may in each case be straight-chain or branched. Unless indicated specifically, preference is given for these radicals to the lower carbon skeletons, e.g. those having 1 to 6 carbon atoms, especially 1 to 4 carbon atoms, or in the case of unsaturated groups having 2 to 6 carbon atoms, especially 2 to 4 carbon atoms. Alkyl radicals, both alone and in composite definitions such as alkoxy, haloalkyl, etc., are for example methyl, ethyl, n-propyl or isopropyl, n-butyl, isobutyl, tert-butyl or 2-butyl, pentyls, hexyls, such as n-hexyl, isohexyl, and 1,3-dimethylbutyl, heptyls, such as n-heptyl, 1-methylhexyl, and 1,4-dimethylpentyl; alkenyl and alkynyl radicals have the definition of the possible unsaturated radicals corresponding to the alkyl radicals; at least one double bond or triple bond is present, preferably one double bond or triple bond, respectively. Alkenyl is for example vinyl, allyl, 1-methylprop-2-en-1-yl, 2-methylprop-2-en-1-yl, but-2-en-1-yl, but-3-en-1-yl, 1-methylbut-3-en-1-yl, and 1-methylbut-2-en-1-yl; alkynyl is for example ethynyl, propargyl, but-2-yn-1-yl, but-3-yn-1-yl, and 1-methylbut-3-yn-1-yl.

Halogen is fluorine, chlorine, bromine or iodine. Haloalkyl, haloalkenyl, and haloalkynyl are alkyl, alkenyl or alkynyl, respectively, which are fully or partly substituted by halogen, preferably by fluorine, chlorine or bromine, in particular by fluorine and/or chlorine, examples being monohaloalkyl (i.e., monohalogenalkyl), perhaloalkyl, CF₃, CHF₂, CH₂F, CF₃CF₂, CH₂FCHCl, CCl₃, CHCl₂, CH₂CH₂Cl; haloalkoxy is for example OCF₃, OCHF₂, OCH₂F, CF₃CF₂O, OCH₂CF₃, and OCH₂CH₂Cl; this correspondingly applies to haloalkenyl and other halogen-substituted radicals.

Aryl is a monocyclic, bicyclic or polycyclic aromatic system, phenyl or naphthyl for example, preferably phenyl.

A heterocyclic radical or ring (heterocyclyl or heteroaryl) can be saturated, unsaturated or heteroaromatic; unless otherwise defined, it preferably comprises one or more, especially 1, 2 or 3 heteroatoms in the heterocyclic ring, preferably from the group of N, O, and S; preferably it is an aliphatic heterocyclyl radical having 3 to 7 ring atoms or a heteroaromatic radical having 5 or 6 ring atoms. The heterocyclic radical may for example be a heteroaromatic radical or ring (heteroaryl), such as a monocyclic, bicyclic or polycyclic aromatic system in which at least 1 ring contains one or more heteroatoms. Preferably it is a heteroaromatic ring with a heteroatom from the group of N, O, and S, such as pyridyl, pyrrolyl, thienyl or furyl, for example; with further preference it is a corresponding heteroaromatic ring having 2 or 3 heteroatoms, such as pyrimidinyl, pyridazinyl, pyrazinyl, triazinyl, thiazolyl, thiadiazolyl, oxazolyl, isoxazolyl, pyrazolyl, imidazolyl, and triazolyl. Furthermore preferably it is a partially or fully hydrogenated heterocyclic radical having a heteroatom from the group of N, O, and S, such as oxiranyl, oxetanyl, oxolanyl (=tetrahydrofuryl), oxanyl, pyrrolidyl (=pyrrolidinyl) or piperidyl or else pyrrolinyl such as Δ¹-pyrrolinyl, Δ²-pyrrolinyl or Δ³-pyrrolinyl, e.g., Δ¹-pyrrolin-2-yl, Δ¹-pyrrolin-3-yl, Δ¹ pyrrolin-4-yl or Δ¹-pyrrolin-5-yl or Δ²-pyrrolin-1-yl, Δ²-pyrrolin-2-yl, Δ²-pyrrolin-3-yl, Δ²-pyrrolin-4-yl, Δ²-pyrrolin-5-yl or Δ³-pyrrolin-1-yl, Δ³-pyrrolin-2-yl or Δ³-pyrrolin-3-yl. Likewise with preference it is a partially or fully hydrogenated heterocyclic radical having 2 heteroatoms from the group of N, O, and S, such as piperazinyl, dioxanyl, dioxolanyl, oxazolinyl, isoxazolinyl, oxazolidinyl, isoxazo idinyl, and morpholinyl.

By the formulation to the effect that, in the case of substituted aryl and heteroaryl radicals, “alkyl, alkoxy or haloalkoxy radicals are, if desired, linked cyclically to one another, with the proviso that they are in ortho position” is meant, for example, the groups benzo-1,4-dioxanyl, 1,3-benzodioxolyl, chromanyl, 3,4-dihydro-1H-chromanyl, 2,3-dihydro-1-benzofuran, 1,3-dihydro-1-benzofuranyl, indanyl, 1,2,3,4-tetrahydronaphthyl, and their analogs with halogenation, especially fluorination, on the saturated carbon units.

Suitable substituents for a substituted heterocyclic radical are the substituents specified later on below, and oxo as well. The oxo group may also occur on the hetero-ring atoms which are able to exist in different oxidation states, as in the case of N and S, for example.

The definition “substituted by one or more radicals” refers, unless otherwise defined, to one or more identical or different radicals.

The substituents given by way of example (“first substituent level”) can, if they include hydrocarbon-containing fractions, be further substituted therein if desired (“second substituent level”), by for example one of the substituents as defined for the first substituent level. Corresponding further substituent levels are possible. The term “substituted radical” preferably embraces just one or two substituent levels.

In the case of radicals having carbon atoms preference is given to those having 1 to 6 carbon atoms, preferably 1 to 4 carbon atoms, particularly 1 or 2 carbon atoms. Preference is generally given to substituents from the group of halogen, such as fluorine and chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro, and cyano.

Unsubstituted or substituted phenyl is preferably phenyl which is unsubstituted or substituted one or more times, preferably up to three times, by identical or different radicals from the group of halogen, (C₁-C₄)-alkyl, (C₁-C₄)-alkoxy, (C₁-C₄)-haloalkyl, (C₁-C₄)-haloalkoxy, and nitro, examples being o-, m-, and p-tolyl, dimethylphenyls, 2-, 3-, and 4-chlorophenyl, 2-, 3-, and 4-trifluoromethyl- and 2-, 3-, and 4-trichloromethylphenyl, 2,4-, 3,5-, 2,5-, and 2,3-dichlorophenyl, and o-, m-, and p-methoxyphenyl.

An acid radical of an organic or inorganic oxygen acid is a radical formed formally by removal of a hydroxyl group from the acid function, an example being the sulfo radical —SO₃H, which is derived from sulfuric acid H₂SO₄, or the sulfino radical —SO₂H, which is derived from sulfurous acid H₂SO₃, or, correspondingly, the group SO₂NH₂, the phospho radical —PO(OH)₂, the group —PO(NH₂)₂, —PO(OH)(NH₂), —PS(OH)₂, —PS(NH₂)₂ or —PS(OH)(NH₂), the carboxyl radical COOH, which is derived from carbonic acid, radicals of the formula —CO—SH, —CS—OH, —CS—SH, —CO—NH₂, —CS—NH₂, —C(═NH)—OH or —C(═NH)—NH₂; also suitable are radicals with hydrocarbon radicals or substituted hydrocarbon radicals, i.e., acyl radicals in the wider sense (i.e., “acyl”).

The safeners are preferably selected from the group consisting of:

A) compounds of the formula (S-I)

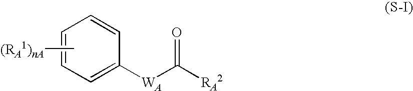

where the symbols and indices have the following meanings:
n_{A} is a natural number from 0 to 5, preferably from 0 to 3;
R_{A}¹ is halogen, (C₁-C₄)-alkyl, (C₁-C₄)-alkoxy, nitro or (C₁-C₄)-haloalkyl;
W_{A} is an unsubstituted or substituted divalent heterocyclic radical from the group consisting of partially unsaturated or aromatic five-membered heterocycles having 1 to 3 hetero ring atoms of the type N or O, where at least one a radical from the group consisting of (W_{A}¹) to (W_{A}⁴),

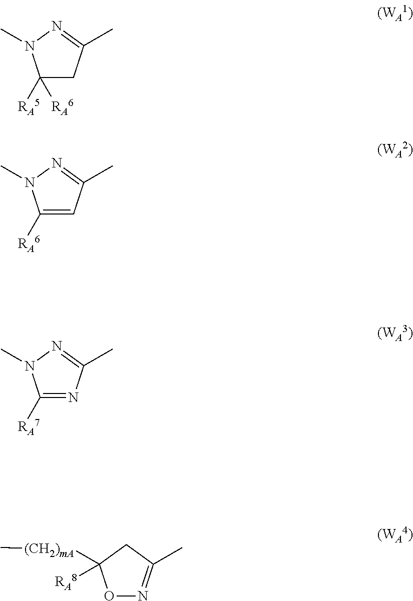

m_{A} is 0 or 1;
R_{A}² is OR_{A}³, SR_{A}³ or NR_{A}³R_{A}⁴ or a saturated
   or unsaturated 3- to 7-membered heterocycle having at least one nitrogen atom and up to 3 heteroatoms, preferably from the group consisting of O and S, which is attached via the nitrogen atom to the carbonyl group in (S-I) and which is unsubstituted or substituted by radicals from the group consisting of (C₁-C₄)-alkyl, (C₁-C₄)-alkoxy and optionally substituted phenyl, preferably a radical of the formula OR_{A}³, NHR_{A}⁴ or N(CH₃)₂, in particular of the formula OR_{A}³;
R_{A}³ is hydrogen or an unsubstituted or substituted aliphatic hydrocarbon radical having preferably a total of 1 to 18 carbon atoms;
R_{A}⁴ is hydrogen, (C₁-C₆)-alkyl, (C₁-C₆)-alkoxy or substituted or unsubstituted phenyl;
R_{A}⁵ is H, (C₁-C₈)-alkyl, (C₁-C₈)-haloalkyl, (C₁-C₄)-alkoxy-(C₁-C₈)-alkyl, cyano or COOR_{A}⁹ where R_{A}⁹ is hydrogen, (C₁-C₈)-alkyl, (C₁-C₈)-haloalkyl, (C₁-C₄)-alkoxy-(C₁-C₄)-alkyl, (C₁-C₆)-hydroxyalkyl, (C₃-C₁₂)-cycloalkyl or tri-(C₁-C₄)-alkylsilyl;
R_{A}⁶, R_{A}⁷, R_{A}⁸ are identical or different and are hydrogen, (C₁-C₈)-alkyl, (C₁-C₈)-haloalkyl, (C₃-C₁₂)-cycloalkyl or substituted or unsubstituted phenyl;
   preferably:
   a) compounds of the type of the dichlorophenylpyrazoline-3-carboxylic acid, preferably compounds such as ethyl 1-(2,4-dichlorophenyl)-5-(ethoxycarbonyl)-5-methyl-2-pyrazoline-3-carboxylate (51-1) (“mefenpyr-diethyl”, see Pestic. Man.), and related compounds, as described in WO 91/07874;
   b) derivatives of dichlorophenylpyrazolecarboxylic acid preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4), ethyl 1-(2,4-dichlorophenyl)-5-phenylpyrazole-3-carboxylate (S1-5) and related compounds, as described in EP-A-333 131 and EP-A-269 806;
   c) compounds of the type of the triazolecarboxylic acids, preferably compounds such as fenchlorazole(-ethyl), i.e. ethyl 1-(2,4-dichlorophenyl)-5-trichloro-methyl-(1H)-1,2,4-triazole-3-carboxylate (S1-6), and related compounds, as described in EP-A-174 562 and EP-A-346 620;
   d) compounds of the type of the 5-benzyl- or 5-phenyl-2-isoxazoline-3-carboxylic acid or the 5,5-diphenyl-2-isoxazoline-3-carboxylic acid, preferably compounds such as ethyl 5-(2,4-dichlorobenzyl)-2-isoxazoline-3-carboxylate (S1-7) or ethyl 5-phenyl-2-isoxazoline-3-carboxylate (S1-8) and related compounds, as described in WO 91/08202, or ethyl 5,5-diphenyl-2-isoxazolinecarboxylate (S1-9) (“isoxadifenethyl”) or n-propyl 5,5-diphenyl-2-isoxazolinecarboxylate (S1-10) or ethyl 5-(4-fluorophenyl)-5-phenyl-2-isoxazoline-3-carboxylate (S1-11), as described in the patent application WO-A-95/07897.
   B) Quinoline derivatives of the formula (S-II)

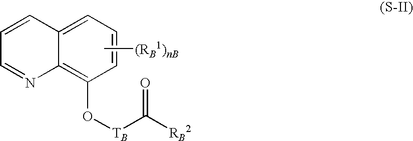

where the symbols and indices have the following meanings:
R_{B}¹ is halogen, (C₁-C₄)-alkyl, (C₁-C₄)-alkoxy, nitro or (C₁-C₄)-haloalkyl;
n_{B} is a natural number from 0 to 5, preferably from 0 to 3;
R_{B}² is OR_{B}^{S}, SR_{B}³ or NR_{B}³R_{B}⁴ or a saturated or unsaturated 3- to 7-membered heterocycle having at least one nitrogen atom and up to 3 heteroatoms, preferably from the group consisting of O and S, which is attached via the nitrogen atom to the carbonyl group in (S-II) and is unsubstituted or substituted by radicals from the group consisting of (C₁-C₄)-alkyl, (C₁-C₄)-alkoxy or optionally substituted phenyl, preferably a radical of the formula OR_{B}³, NHR_{B}⁴ or N(CH₃)₂, in particular of the formula OR_{B}³;
R_{B}³ is hydrogen or an unsubstituted or substituted aliphatic hydrocarbon radical having preferably a total of 1 to 18 carbon atoms;
R_{B}⁴ is hydrogen, (C₁-C₆)-alkyl, (C₁-C₆)-alkoxy or substituted or unsubstituted phenyl;
T_{B} is a (C₁— or C₂)-alkanediyl chain which is unsubstituted or substituted by one or two (C₁-C₄)-alkyl radicals or by [(C₁-C₃)-alkoxy]carbonyl;
preferably:
a) compounds of the type of the 8-quinolinoxyacetic acid (S2), preferably 1-methylhexyl (5-chloro-8-quinolinoxy)acetate (common name “cloquintocet-mexyl” (S2-1) (see Pestic. Man.),
1,3-dimethyl-but-1-yl (5-chloro-8-quinolinoxy)acetate (S2-2),
4-allyloxybutyl (5-chloro-8-quinolinoxy)acetate (S2-3),
1-allyloxyprop-2-yl (5-chloro-8-quinolinoxy)acetate (S2-4),
ethyl(5-chloro-8-quinolinoxy)acetate (S2-5),
methyl(5-chloro-8-quinolinoxy)acetate (S2-6),
allyl(5-chloro-8-quinolinoxy)acetate (S2-7),
2-(2-propylideneiminoxy)-1-ethyl (5-chloro-8-quinolinoxy)acetate (S2-8), 2-oxo-prop-1-yl (5-chloro-8-quinolinoxy)acetate (S2-9) and related compounds, as described in EP-A-86 750, EP-A-94 349 and EP-A-191 736 or EP-A-0 492 366, and also their hydrates and salts, as described in WO-A-2002/034048;
   b) compounds of the type of the (5-chloro-8-quinolinoxy)malonic acid, preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.
   C) Compounds of the formula (S-III)

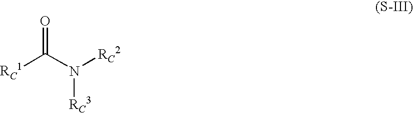

where the symbols and indices have the following meanings:
R_{C}¹ is (C₁-C₄)-alkyl, (C₁-C₄)-haloalkyl, (C₂-C₄)-alkenyl, (C₂-C₄)-haloalkenyl, (C₃-C₇)-cycloalkyl, preferably dichloromethyl;
R_{C}², R_{C}³ are identical or different and are hydrogen, (C₁-C₄)-alkyl, (C₂-C₄)-alkenyl, (C₂-C₄)-alkynyl, (C₁-C₄)-haloalkyl, (C₂-C₄)-haloalkenyl, (C₁-C₄)-alkylcarbamoyl-(C₁-C₄)-alkyl, (C₂-C₄)-alkenylcarbamoyl-(C₁-C₄)-alkyl, (C₁-C₄)-alkoxy-(C₁-C₄)-alkyl, dioxolanyl-(C₁-C₄)-alkyl, thiazolyl, furyl, furylalkyl, thienyl, piperidyl, substituted or unsubstituted phenyl, or R_{C}² and R_{C}³ together form a substituted or unsubstituted heterocyclic ring,
preferably an oxazolidine, thiazolidine, piperidine, morpholine, hexahydropyrimidine or benzoxazine ring;
preferably:
active compounds of the type of the dichloroacetamides which are frequently used as pre-emergence safeners (soil-acting safeners), such as, for example,
“dichlormid” (see Pestic.Man.) (=N,N-diallyl-2,2-dichloroacetamide),
“R-29148” (=3-dichloroacetyl-2,2,5-trimethyl-1,3-oxazolidine from Stauffer),
“R-28725” (=3-dichloroacetyl-2,2,-dimethyl-1,3-oxazolidine from Stauffer),
“benoxacor” (see Pestic. Man.) (=4-dichloroacetyl-3,4-dihydro-3-methyl-2H-1,4-benzoxazine),
“PPG-1292” (=N-allyl-N-[(1,3-dioxolan-2-yl)methyl]dichloroacetamide from PPG Industries),
“DKA-24” (=N-allyl-N-[(allylaminocarbonyl)methyl]dichloroacetamide from Sagro-Chem),
“AD-67” or “MON 4660” (=3-dichloroacetyl-1-oxa-3-aza-spiro[4,5]decane from Nitrokemia or Monsanto),
“TI-35” (=1-dichloroacetylazepane from TRI-Chemical RT)
“diclonon” (dicyclonone) or “BAS145138” or “LAB145138” (=3-dichloroacetyl-2,5,5-trimethyl-1,3-diazabicyclo[4.3.0]nonane from BASF) and
“furilazole” or “MON 13900” (see Pestic. Man.) (=(RS)-3-dichloroacetyl-5-(2-furyl)-2,2-dimethyloxazolidine).
D) N-Acylsulfonamides of the formula (S-IV) and their salts

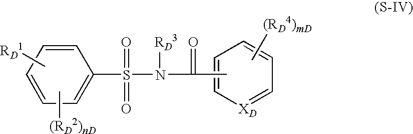

in which

### X_{D} is CH or N;

### R_{D}¹ is CO—NR_{D}⁵R_{D}⁶ or NHCO—R_{D}⁷;

R_{D}² is halogen, (C₁-C₄)-haloalkyl, (C₁-C₄)-haloalkoxy, nitro, (C₁-C₄)-alkyl, (C₁-C₄)-alkoxy, (C₁-C₄)-alkylsulfonyl, (C₁-C₄)-alkoxycarbonyl or (C₁-C₄)-alkylcarbonyl;
R_{D}³ is hydrogen, (C₁-C₄)-alkyl, (C₂-C₄)-alkenyl or (C₂-C₄)-alkynyl;
R_{D}⁴ is halogen, nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl or (C₁-C₄)-alkylcarbonyl;
R_{D}⁵ is hydrogen, (C₁-C₆)-alkyl, (C₃-C₆)-cycloalkyl, (C₂-C₆)-alkenyl, (C₂-C₆)-alkynyl, (C₅-C₆)-cycloalkenyl, phenyl or 3- to 6-membered heterocyclyl containing v_{D} heteroatoms from the group consisting of nitrogen, oxygen and sulfur, where the seven last mentioned radicals are substituted by v_{D} substituents from the group consisting of halogen, (C₁-C₆)-alkoxy, (C₁-C₆)-haloalkoxy, (C₁-C₂)-alkylsulfonyl, (C₃-C₆)-cycloalkyl, (C₁-C₄)-alkoxycarbonyl, (C₁-C₄)-alkylcarbonyl and phenyl and, in the case of cyclic radicals, also (C₁-C₄)-alkyl and (C₁-C₄)-haloalkyl;
R_{D}⁶ is hydrogen, (C₁-C₆)-alkyl, (C₂-C₆)-alkenyl or (C₂-C₆)-alkynyl, where the three last mentioned radicals are substituted by v_{D} radicals from the group consisting of halogen, hydroxy, (C₁-C₄)-alkyl, (C₁-C₄)-alkoxy and (C₁-C₄)-alkylthio, or
R_{D}⁵ and R_{D}⁶ together with the nitrogen atom carrying them form a pyrrolidinyl or piperidinyl radical;
R_{D}⁷ is hydrogen, (C₁-C₄)-alkylamino, di-(C₁-C₄)-alkylamino, (C₁-C₆)-alkyl, (C₃-C₆)-cycloalkyl, where the 2 last mentioned radicals are substituted by V_{D} substituents from the group consisting of halogen, (C₁-C₄)-alkoxy, halo-(C₁-C₆)-alkoxy and (C₁-C₄)-alkylthio and, in the case of cyclic radicals, also (C₁-C₄)-alkyl and (C₁-C₄)-haloalkyl;
n_{D} is 0, 1 or 2;
m_{D} is 1 or 2;
v_{D} is 0, 1, 2 or 3;
from among these, preference is given to compounds of the type of the N-acylsulfonamides, for example of the formula (S-V) below, which are known, for example, from WO 97/45016

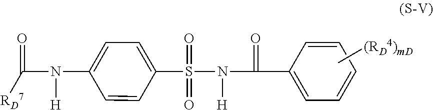

in which
R_{D}⁷ is (C₁-C₆)-alkyl, (C₃-C₆)-cycloalkyl, where the 2 last mentioned radicals are substituted by vₒ substituents from the group consisting of halo, (C₁-C₄)-alkoxy, halo-(C₁-C₆)-alkoxy and (C₁-C₄)-alkylthio and, in the case of cyclic radicals, also (C₁-C₄)-alkyl and (C₁-C₄)-haloalkyl;
R_{D}⁴ is halogen, (C₁-C₄)-alkyl, (C₁-C₄)-alkoxy, CF₃;
m_{D} is 1 or 2;
v_{D} is 0, 1, 2 or 3;
and also
acylsulfamoylbenzamides, for example of the formula (S-VI) below, which are known, for example, from WO 99/16744,

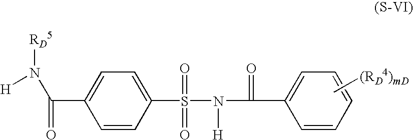

for example those in which
R_{D}⁵=cyclopropyl and (R_{D}⁴)=2-OMe (“cyprosulfamide”, S3-1),
R_{D}⁵=cyclopropyl and (R_{D}⁴)=5-C₁₋₂-OMe (S3-2),
R_{D}⁵=ethyl and (R_{D}⁴)=2-OMe (S3-3),
R_{D}⁵=isopropyl and (R_{D}⁴)=5-C₁-2-OMe (S3-4) and
R_{D}⁵=isopropyl and (R_{D}⁴)=2-OMe (S3-5);
and also
compounds of the type of the N-acylsulfamoylphenylureas of the formula (S-VII), which are known, for example, from EP-A-365484

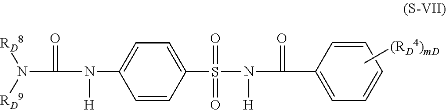

in which
R_{D}⁸ and R_{D}⁹ independently of one another are hydrogen, (C₁-C₈)-alkyl, (C₃-C₈)-cycloalkyl, (C₃-C₆)-alkenyl, (C₃-C₆)-alkynyl,
R_{D}⁴ is halogen, (C₁-C₄)-alkyl, (C₁-C₄)-alkoxy, CF₃
m_{D} is 1 or 2;
from among these in particular
1-[4-(N-2-methoxybenzoylsulfamoyl)phenyl]-3-methylurea (S4-1),
1-[4-(N-2-methoxybenzoylsulfamoyl)phenyl]-3,3-dimethylurea (S4-2),
1-[4-(N-4,5-dimethylbenzoylsulfamoyl)phenyl]-3-methylurea (S4-3),
1-[4-(N-naphthoylsulfamoyl)phenyl]-3,3-dimethylurea (S4-4),
   G) active compounds from the class of the hydroxyaromatics and aromatic-aliphatic carboxylic acid derivatives, for example
   ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicyclic acid, 1,2-dihydro-2-oxo-6-trifluoromethylpyridine-3-carboxamide, 2-hydroxycinnamic acid, 2,4-dichlorocinnamic acid, as described in WO 2004084631, WO 2005015994, WO 2006007981, WO 2005016001;
   H) active compounds from the class of the 1,2-dihydroquinoxalin-2-ones, for example
   1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulfonylaminoethyl)-3-(2-thienyl)-1,2-dihydroquinoxalin-2-one, 1-[2-(diethylamino)ethyl]-6,7-dimethyl-3-(2-thienyl)quinoxaline (S5-1), as described in WO 2005112630,
   I) active compounds which, in addition to a herbicidal action against harmful plants, also have safener action on crop plants such as rice, such as, for example, “dimepiperate” or “MY-93” (see Pestic. Man.) (═S-1-methyl-1-phenylethyl piperidine-1-thiocarboxylate), which is known as safener for rice against damage by the herbicide molinate,
   “daimuron” or “SK 23” (see Pestic. Man.) (=1-(1-methyl-1-phenylethyl)-3-p-tolyl-urea), which is known as safener for rice against damage by the herbicide imazosulfuron,
   “cumyluron”=“JC-940” (=3-(2-chlorophenylmethyl)-1-(1-methyl-1-phenylethyl)urea, see JP-A-60087254), which is known as safener for rice against damage by a number of herbicides,
   “methoxyphenone” or “NK 049” (=3,3′-dimethyl-4-methoxybenzophenone), which is known as safener for rice against damage by a number of herbicides,
   “CSB” (=1-bromo-4-(chloromethylsulfonyl)benzene) (CAS Reg. No. 54091-06-4 from Kumiai), which is known as safener against damage by a number of herbicides in rice,
   K) compounds of the formula (S-IX),
   as described in WO-A-1998/38856

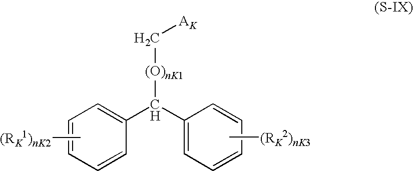

in which the symbols and indices have the following meanings:
R_{K}¹, R_{K}² independently of one another are halogen, (C₁-C₄)-alkyl, (C₁-C₄)-alkoxy, (C₁-C₄)-haloalkyl, (C₁-C₄)-alkylamino, di-(C₁-C₄)-alkylamino, nitro;

### A_{K} is COOR_{K}³ or COOR_{K}⁴

R_{K}³, R_{K}⁴ independently of one another are hydrogen, (C₁-C₄)-alkyl, (C₂-C₆)-alkenyl, (C₂-C₄)-alkynyl, cyanoalkyl, (C₁-C₄)-haloalkyl, phenyl, nitrophenyl, benzyl, halobenzyl, pyridinylalkyl or alkylammonium,
n_{K}¹ is 0 or 1,
n_{K}², n_{K}³ independently of one another are 0, 1 or 2
preferably: methyl (diphenylmethoxy)acetate (CAS Reg. No.: 41858-19-9),
L) compounds of the formula (S-X),
as described in WO A-98/27049

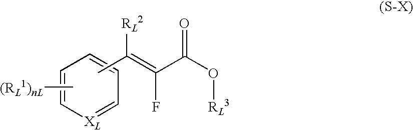

in which the symbols and indices have the following meanings:
X_{L} is CH or N,
n_{L} is, in the case that X═N, an integer from 0 to 4 and,
   in the case that X═CH, an integer from 0 to 5,
R_{L}¹ is halogen, (C₁-C₄)-alkyl, (C₁-C₄)-haloalkyl, (C₁-C₄)-alkoxy, (C₁-C₄)-haloalkoxy, nitro, (C₁-C₄)-alkylthio, (C₁-C₄)-alkylsulfonyl, (C₁-C₄)-alkoxycarbonyl, optionally substituted phenyl, optionally substituted phenoxy,
R_{L}² is hydrogen or (C₁-C₄)-alkyl,
R_{L}³ is hydrogen, (C₁-C₈)-alkyl, (C₂-C₄)-alkenyl, (C₂-C₄)-alkynyl or aryl, where each of the carbon-containing radicals mentioned above is unsubstituted or substituted by one or more, preferably by up to three, identical or different radicals from the group consisting of halogen and alkoxy; or salts thereof.
   M) Active compounds from the class of the 3-(5-tetrazolylcarbonyl)-2-quinolones, for example
   1,2-dihydro-4-hydroxy-1-ethyl-3-(5-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No.: 95855-00-8), as described in WO-A-1999000020,
   N) compounds of the formulae (S-XI) or (S-XII),
   as described in WO-A-2007023719 and WO-A-2007023764

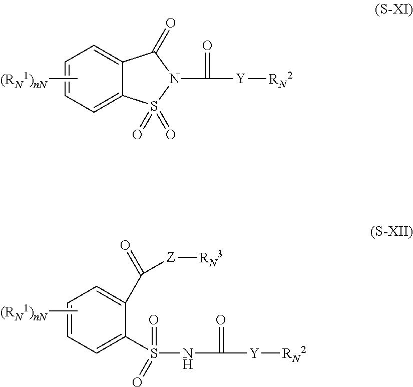

in which
R_{N}¹ is halogen, (C₁-C₄)-alkyl, methoxy, nitro, cyano, CF₃, OCF₃
Y, Z independently of one another are O or S,
n_{N} is an integer from 0 to 4,
R_{N}² is (C₁-C₁₆)-alkyl, (C₂-C₆)-alkenyl, (C₃-C₆)-cycloalkyl, aryl, benzyl, halobenzyl,
R_{N}³ is hydrogen, (C₁-C₆)alkyl;
O) one or more compounds from the group consisting of:
1,8-naphthalic anhydride,
O,O-diethyl S-2-ethylthioethyl phosphorodithioate (disulfoton),
4-chlorophenyl methylcarbamate (mephenate),
O,O-diethyl O-phenyl phosphorothioate (dietholate),
4-carboxy-3,4-dihydro-2H-1-benzopyran-4-acetic acid (CL-04415, CAS Reg. No.: 31541-57-8),
2-propenyl 1-oxa-4-azaspiro[4.5]decane-4-carbodithioate (MG-838, CAS Reg, No.: 133993-74-5),
methyl [(3-oxo-1H-2-benzothiopyran-4(3H)-ylidene)methoxy]acetate (from WO-A-98/13361; CAS Reg. No.: 205121-04-6),
cyanomethoxyimino(phenyl)acetonitrile (cyometrinil),
1,3-dioxolan-2-ylmethoxyimino(phenyl)acetonitrile(oxabetrinil),
4′-chloro-2,2,2-trifluoroacetophenone 0-1,3-dioxolan-2-ylmethyloxime(fluxofenim),
4,6-dichloro-2-phenylpyrimidine (fenclorim),
benzyl 2-chloro-4-trifluoromethyl-1,3-thiazole-5-carboxylate (flurazole),
2-dichloromethyl-2-methyl-1,3-dioxolane (MG-191),
   including the stereoisomers, and the salts customary in agriculture.

A mixture with other known active compounds, such as fungicides, insecticides, acaricides, nematicides, bird repellents, plant nutrients and soil structure improvers is likewise possible.

Some of the safeners are already known as herbicides and accordingly, in addition to the herbicidal action against harmful plants, also act by protecting the crop plants. The weight ratios of herbicide (mixture) to safener generally depend on the herbicide application rate and the effectiveness of the safener in question and may vary within wide limits, for example in the range from 200:1 to 1:200, preferably from 100:1 to 1:100, in particular from 20:1 to 1:20. The safeners may be formulated analogously to the compounds of the formula (I) or their mixtures with other herbicides/pesticides and be provided and used as a finished formulation or as a tank mix with the herbicides.

Examples of preferred combinations of herbidically active compounds (A) and safeners (B) are:

(A-0)+(S1-1), (A-0)+(S1-2), (A-0)+(S1-3), (A-0)+(S1-4), (A-0)+(S1-5), (A-0)+(S1-6), (A-0)+(S1-7), (A-0)+(S1-8), (A-0)+(S1-9), (A-0)+(S1-10), (A-0)+(S1-11), (A-0)+(S2-1), (A-0)+(S2-2), (A-0)+(S2-3), (A-0)+(S2-4), (A-0)+(S2-5), (A-0)+(S2-6), (A-0)+(S2-7), (A-0)+(S2-8), (A-0)+(S2-9), (A-0)+(S3-1), (A-0)+(S3-2), (A-0)+(S3-3), (A-0)+(S3-4), (A-0)+(S3-5), (A-0)+(S4-1), (A-0)+(S4-2), (A-0)+(S4-3), (A-0)+(S4-4); (A-0)+(S5-1);
(A-1)+(S1-1), (A-1)+(S1-2), (A-1)+(S1-3), (A-1)+(S1-4), (A-1) (S1-5), (A-1)+(S1-6), (A-1)+(S1-7), (A-1)+(S1-8), (A-1) (S1-9), (A-1)+(S1-10), (A-1)+(S1-11), (A-1)+(S2-1), (A-1) (S2-2), (A-1) (S2-3), (A-1)+(S2-4), (A-1)+(S2-5), (A-1) (S2-6), (A-1) (S2-7), (A-1)+(S2-8), (A-1)+(S2-9), (A-1)+(S3-1), (A-1)+(S3-2), (A-1)+(S3-3), (A-1)+(S3-4), (A-1)+(S3-5), (A-1)+(S4-1), (A-1)+(S4-2), (A-1)+(S4-3), (A-1)+(S4-4); (A-1)+(S5-1);
(A-2)+(S1-1), (A-2)+(S1-2), (A-2)+(S1-3), (A-2)+(S1-4), (A-2)+(S1-5), (A-2)+(S1-6), (A-2)+(S1-7), (A-2)+(S1-8), (A-2)+(S1-9), (A-2)+(S1-10), (A-2)+(51-11), (A-2)+(S2-1), (A-2)+(S2-2), (A-2)+(S2-3), (A-2)+(S2-4), (A-2)+(S2-5), (A-2)+(S2-6), (A-2)+(S2-7), (A-2)+(S2-8), (A-2)+(S2-9), (A-2)+(S3-1), (A-2)+(S3-2), (A-2)+(S3-3), (A-2)+(S3-4), (A-2)+(S3-5), (A-2)+(S4-1), (A-2)+(S4-2), (A-2)+(S4-3), (A-2)+(S4-4); (A-2)+(S5-1);
(A-3)+(S1-1), (A-3)+(S1-2), (A-3)+(S1-3), (A-3)+(S1-4), (A-3)+(S1-5), (A-3)+(S1-6), (A-3)+(S1-7), (A-3)+(S1-8), (A-3)+(S1-9), (A-3)+(S1-10), (A-3)+(S1-11), (A-3)+(S2-1), (A-3)+(S2-2), (A-3)+(S2-3), (A-3)+(S2-4), (A-3)+(S2-5), (A-3)+(S2-6), (A-3)+(S2-7), (A-3)+(S2-8), (A-3)+(S2-9). (A-3)+(S3-1), (A-3)+(S3-2), (A-3) (S3-3), (A-3)+(S3-4), (A-3)+(S3-5), (A-3)+(S4-1), (A-3)+(S4-2), (A-3)+(S4-3), (A-3)+(S4-4); (A-3)+(S5-1);
(A-4) (S1-1), (A-4)+(S1-2), (A-4)+(S1-3), (A-4)+(S1-4), (A-4) (S1-5), (A-4)+(S1-6), (A-4)+(S1-7), (A-4)+(S1-8), (A-4)+(S1-9), (A-4)+(51-10), (A-4)+(S1-11), (A-4)+(S2-1), (A-4)+(S2-2), (A-4)+(S2-3), (A-4)+(S2-4), (A-4)+(S2-5), (A-4)+(S2-6), (A-4)+(S2-7), (A-4)+(S2-8), (A-4)+(S2-9), (A-4)+(S3-1), (A-4)+(S3-2), (A-4)+(S3-3), (A-4)+(S3-4), (A-4)+(S3-5), (A-4)+(S4-1), (A-4)+(S4-2), (A-4)+(S4-3), (A-4)+(S4-4); (A-4)+(S5-1);
(A-5)+(S1-1), (A-5)+(S1-2), (A-5)+(S1-3), (A-5)+(S1-4), (A-5)+(S1-5), (A-5)+(S1-6), (A-5)+(S1-7), (A-5)+(S1-8), (A-5)+(S1-9), (A-5)+(S1-10), (A-5)+(S1-11), (A-5)+(S2-1), (A-5)+(S2-2), (A-5)+(S2-3), (A-5)+(S2-4), (A-5)+(S2-5), (A-5)+(S2-6), (A-5)+(S2-7), (A-5)+(S2-8), (A-5)+(S2-9), (A-5)+(S3-1), (A-5)+(S3-2), (A-5)+(S3-3), (A-5)+(S3-4), (A-5)+(S3-5), (A-5)+(S4-1), (A-5)+(S4-2), (A-5)+(S4-3), (A-5)+(S4-4); (A-5)+(S5-1);
(A-6)+(S1-1), (A-6)+(S1-2), (A-6)+(S1-3), (A-6)+(S1-4), (A-6)+(S1-5), (A-6)+(S1-6), (A-6)+(S1-7), (A-6)+(S1-8), (A-6)+(S1-9), (A-6)+(51-10), (A-6)+(S1-11), (A-6)+(S2-1), (A-6)+(S2-2), (A-6)+(S2-3), (A-6)+(S2-4), (A-6)+(S2-5), (A-6)+(S2-6), (A-6)+(S2-7), (A-6)+(S2-8), (A-6)+(S2-9), (A-6)+(S3-1), (A-6)+(S3-2), (A-6)+(S3-3), (A-6)+(S3-4), (A-6)+(S3-5), (A-6)+(S4-1), (A-6)+(S4-2), (A-6)+(S4-3), (A-6)+(S4-4); (A-6)+(S5-1);
(A-7)+(S1-1), (A-7)+(S 2), (A-7)+(S1-3), (A-7)+(S1-4), (A-7)+(S1-5), (A-7) S1-6), (A-7)+(S1-7), (A-7)+(S1-8), (A-7)+(S1-9), (A-7)+(S1-10), (A-7)+(51-11), (A-7)+(S2-1), (A-7)+(S2-2), (A-7)+(S2-3), (A-7)+(S2-4), (A-7)+(S2-5), (A-7)+(S2-6), (A-7)+(S2-7), (A-7)+(S2-8), (A-7)+(S2-9), (A-7)+(S3-1), (A-7)+(S3-2), (A-7)+(S3-3), (A-7)+(S3-4), (A-7)+(S3-5), (A-7)+(S4-1), (A-7)+(S4-2), (A-7)+(S4-3), (A-7)+(S4-4); (A-7)+(S5-1);
(A-8)+(S1-1), (A-8)+(S1-2), (A-8)+(S1-3), (A-8)+(S1-4), (A-8)+(S1-5), (A-8)+(S1-6), (A-8)+(S1-7), (A-8)+(S1-8), (A-8)+(S1-9), (A-8)+(S1-10), (A-8)+(S1-11), (A-8)+(S2-1), (A-8)+(S2-2), (A-8)+(S2-3), (A-8)+(S2-4), (A-8)+(S2-5), (A-8)+(S2-6), (A-8)+(S2-7), (A-8)+(S2-8), (A-8)+(S2-9), (A-8)+(S3-1), (A-8)+(S3-2), (A-8)+(S3-3), (A-8)+(S3-4), (A-8)+(S3-5), (A-8)+(S4-1), (A-8)+(S4-2), (A-8)+(S4-3), (A-8)+(S4-4); (A-8)+(S5-1);
(A-9)+(S1-1), (A-9)+(S1-2), (A-9)+(S1-3), (A-9)+(S1-4), (A-9)+(S1-5), (A-9)+(S1-6), (A-9)+(S1-7), (A-9)+(S1-8), (A-9)+(S1-9), (A-9)+(S1-10), (A-9)+(S1-11), (A-9)+(S2-1), (A-9)+(S2-2), (A-9)+(S2-3), (A-9)+(S2-4), (A-9)+(S2-5), (A-9)+(S2-6), (A-9)+(S2-7), (A-9)+(52-8), (A-9)+(S2-9), (A-9)+(S3-1), (A-9)+(S3-2), (A-9)+(S3-3), (A-9)+(S3-4), (A-9)+(S3-5), (A-9)+(S4-1), (A-9)+(S4-2), (A-9)+(S4-3), (A-9)+(S4-4); (A-9)+(S5-1);
(A-10)+(S1-1), (A-10)+(S1-2), (A-10)+(S1-3), (A-10)+(S1-4), (A-10)+(S1-5), (A-10)+(S1-6), (A-10)+(S1-7), (A-10)+(S1-8), (A-10)+(S1-9), (A-10)+(S1-10), (A-10)+(S1-11), (A-10)+(S2-1), (A-10)+(S2-2), (A-10)+(S2-3), (A-10)+(S2-4), (A-10)+(S2-5), (A-10)+(S2-6), (A-10)+(S2-7), (A-10)+(S2-8), (A-10)+(S2-9), (A-10)+(S3-1), (A-10)+(S3-2), (A-10)+(S3-3), (A-10)+(S3-4), (A-10)+(S3-5), (A-10)+(S4-1), (A-10)+(S4-2), (A-10)+(S4-3), (A-10)+(S4-4); (A-10)+(S5-1);
(A-11)+(S1-1), (A-11)+(S1-2), (A-11)+(S1-3), (A-11)+(S1-4), (A-11)+(S1-5), (A-11)+(S1-6), (A-11)+(S1-7), (A-11)+(S1-8), (A-11)+(S1-9), (A-11)+(S1-10), (A-11)+(S1-11), (A-11)+(S2-1), (A-11)+(S2-2), (A-11)+(S2-3), (A-11)+(S2-4), (A-11)+(S2-5), (A-11)+(S2-6), (A-11)+(S2-7), (A-11)+(S2-8), (A-11)+(S2-9), (A-11)+(S3-1), (A-11)+(S3-2), (A-11)+(S3-3), (A-11)+(S3-4), (A-11)+(S3-5), (A-11)+(S4-1), (A-11)+(S4-2), (A-11)+(S4-3), (A-11)+(S4-4); (A-11)+(S5-1);
(A-12)+(S1-1), (A-12)+(S1-2), (A-12)+(S1-3), (A-12) (S1-4), (A-12)+(S1-5), (A-12)+(S1-6), (A-12)+(S1-7), (A-12)+(S1-8), (A-12)+(S1-9), (A-12)+(S1-10), (A-12)+(S1-11), (A-12)+(S2-1), (A-12)+(S2-2), (A-12)+(S2-3), (A-12)+(S2-4), (A-12)+(S2-5), (A-12)+(S2-6), (A-12)+(S2-7), (A-12)+(S2-8), (A-12)+(S2-9), (A-12)+(S3-1), (A-12)+(S3-2), (A-12)+(S3-3), (A-12)+(S3-4), (A-12)+(S3-5), (A-12)+(S4-1), (A-12)+(S4-2), (A-12)+(S4-3), (A-12)+(S4-4); (A-12)+(S5-1);
(A-13)+(S1-1), (A-13)+(S1-2), (A-13)+(S1-3), (A-13)+(S1-4), (A-13)+(S1-5), (A-13)+(S1-6), (A-13)+(S1-7), (A-13)+(S1-8), (A-13)+(S1-9), (A-13)+(S1-10), (A-13)+(S1-11), (A-13)+(S2-1), (A-13)+(S2-2), (A-13)+(S2-3), (A-13)+(S2-4), (A-13)+(S2-5), (A-13)+(S2-6), (A-13)+(S2-7), (A-13)+(S2-8), (A-13)+(S2-9), (A-13)+(S3-1), (A-13)+(S3-2), (A-13)+(S3-3), (A-13)+(S3-4), (A-13)+(S3-5), (A-13)+(S4-1), (A-13)+(S4-2), (A-13)+(S4-3), (A-13)+(S4-4); (A-13) (S5-1);
(A-14)+(S1-1), (A-14)+(S1-2), (A-14)+(S1-3), (A-14)+(S1-4), (A-14)+(S1-5), (A-14)+(S1-6), (A-14)+(S1-7), (A-14)+(S1-8), (A-14)+(S1-9), (A-14)+(S1-10), (A-14)+(S1-11), (A-14)+(S2-1), (A-14)+(S2-2), (A-14)+(S2-3), (A-14)+(S2-4), (A-14)+(S2-5), (A-14)+(S2-6), (A-14)+(S2-7), (A-14)+(S2-8), (A-14)+(S2-9), (A-14)+(S3-1), (A-14)+(S3-2), (A-14)+(S3-3), (A-14)+(S3-4), (A-14)+(S3-5), (A-14)+(S4-1), (A-14)+(S4-2), (A-14)+(S4-3), (A-14)+(S4-4); (A-14)+(S5-1);
(A-15)+(S1-1), (A-15)+(S1-2), (A-15)+(S1-3), (A-15)+(S1-4), (A-15)+(S1-5), (A-15)+(S1-6), (A-15)+(S1-7), (A-15)+(S1-8), (A-15)+(S1-9), (A-15)+(S1-10), (A-15)+(S1-11), (A-15)+(S2-1), (A-15)+(S2-2), (A-15)+(S2-3), (A-15)+(S2-4), (A-15)+(S2-5), (A-15)+(S2-6), (A-15)+(S2-7), (A-15)+(S2-8), (A-15)+(S2-9), (A-15)+(S3-1), (A-15)+(S3-2), (A-15)+(S3-3), (A-15)+(S3-4), (A-15)+(S3-5), (A-15)+(S4-1), (A-15)+(S4-2), (A-15)+(S4-3), (A-15)+(S4-4); (A-15)+(S5-1);
(A-16)+(S1-1), (A-16)+(S1-2), (A-16)+(S1-3), (A-16)+(S1-4), (A-16)+(S1-5), (A-16)+(S1-6), (A-16)+(S1-7), (A-16)+(S1-8), (A-16)+(S1-9), (A-16)+(S1-10), (A-16)+(S1-11), (A-16)+(S2-1), (A-16)+(S2-2), (A-16)+(S2-3), (A-16)+(S2-4), (A-16)+(S2-5), (A-16)+(S2-6), (A-16)+(S2-7), (A-16)+(S2-8), (A-16)+(S2-9), (A-16)+(S3-1), (A-16)+(S3-2), (A-16)+(S3-3), (A-16)+(S3-4), (A-16)+(S3-5), (A-16)+(S4-1), (A-16)+(S4-2), (A-16)+(S4-3), (A-16)+(S4-4); (A-16)+(S5-1);
(A-17)+(S1-1), (A-17)+(S1-2), (A-17)+(S1-3), (A-17)+(S1-4), (A-17)+(S1-5), (A-17)+(S1-6), (A-17)+(S1-7), (A-17)+(S1-8), (A-17)+(S1-9), (A-17)+(S1-10), (A-17)+(S1-11), (A-17)+(S2-1), (A-17)+(S2-2), (A-17)+(S2-3), (A-17)+(S2-4), (A-17)+(S2-5), (A-17)+(S2-6), (A-17)+(S2-7), (A-17)+(S2-8), (A-17)+(S2-9), (A-17)+(S3-1), (A-17)+(S3-2), (A-17)+(S3-3), (A-17)+(S3-4), (A-17)+(S3-5), (A-17)+(S4-1), (A-17)+(S4-2), (A-17)+(S4-3), (A-17)+(S4-4); (A-17)+((S5-1);
(A-18)+(S1-1), (A-18) S1-2), (A-18)+(S1-3), (A-18)+(S1-4), (A-18)+(S1-5), (A-18)+(S1-6), (A-18)+(S1-7), (A-18)+(S1-8), (A-18)+(S1-9), (A-18)+(S1-10), (A-18)+(S1-11), (A-18)+(S2-1), (A-18)+(S2-2), (A-18)+(S2-3), (A-18)+(52-4), (A-18)+(S2-5), (A-18)+(S2-6), (A-18)+(S2-7), (A-18)+(S2-8), (A-18)+(S2-9), (A-18)+(S3-1), (A-18)+(S3-2), (A-18)+(S3-3), (A-18)+(S3-4), (A-18)+(S3-5), (A-18)+(S4-1), (A-18)+(S4-2), (A-18)+(S4-3), (A-18)+(S4-4); (A-18)+(S5-1);
(A-19)+(S1-1), (A-19)+(S1-2), (A-19)+(S1-3), (A-19)+(S1-4), (A-19)+(S1-5), (A-19)+(S1-6), (A-19)+(S1-7), (A-19)+(S1-8), (A-19)+(S1-9), (A-19)+(S1-10), (A-19)+(S1-11), (A-19)+(S2-1), (A-19)+(S2-2), (A-19)+(S2-3), (A-19)+(S2-4), (A-19)+(S2-5), (A-19)+(S2-6), (A-19)+(S2-7), (A-19)+(S2-8), (A-19)+(S2-9), (A-19)+(S3-1), (A-19)+(S3-2), (A-19)+(S3-3), (A-19)+(S3-4), (A-19)+(S3-5), (A-19)+(S4-1), (A-19)+(S4-2), (A-19)+(S4-3), (A-19)+(S4-4); (A-19)+(S5-1);
(A-20)+(S1-1), (A-20)+(S1-2), (A-20)+(S1-3), (A-20)+(S1-4), (A-20)+(S1-5), (A-20)+(S1-6), (A-20)+(S1-7), (A-20)+(S1-8), (A-20)+(S1-9), (A-20)+(S1-10), (A-20)+(S1-11), (A-20)+(52-1), (A-20)+(S2-2), (A-20)+(S2-3), (A-20)+(S2-4), (A-20)+(S2-5), (A-20)+(S2-6), (A-20)+(S2-7), (A-20)+(S2-8), (A-20)+(S2-9), (A-20)+(S3-1), (A-20)+(S3-2), (A-20)+(S3-3), (A-20)+(S3-4), (A-20)+(S3-5), (A-20)+(S4-1), (A-20)+(S4-2), (A-20)+(S4-3), (A-20)+(S4-4); (A-20)+(S5-1);
(A-21)+(S1-1), (A-21)+(S1-2), (A-21)+(S1-3), (A-21)+(S1-4), (A-21)+(S1-5), (A-21)+(S1-6), (A-21)+(S1-7), (A-21)+(S1-8), (A-21)+(S1-9), (A-21)+(S1-10), (A-21)+(S1-11), (A-21)+(S2-1), (A-21)+(S2-2), (A-21)+(S2-3), (A-21)+(S2-4), (A-21)+(S2-5), (A-21)+(S2-6), (A-21)+(S2-7), (A-21)+(S2-8), (A-21)+(S2-9), (A-21)+(53-1), (A-21)+(S3-2), (A-21)+(S3-3), (A-21)+(S3-4), (A-21)+(S3-5), (A-21)+(S4-1), (A-21)+(S4-2), (A-21)+(S4-3), (A-21)+(S4-4); (A-21)+(S5-1);
(A-22)+(S1-1), (A-22)+(S1-2), (A-22)+(51-3), (A-22)+(S1-4), (A-22)+(S1-5), (A-22)+(S1-6), (A-22)+(S1-7), (A-22)+(S1-8), (A-22)+(S1-9), (A-22)+(S1-10), (A-22)+(S1-11), (A-22)+(S2-1), (A-22)+(S2-2), (A-22)+(S2-3), (A-22)+(S2-4), (A-22)+(S2-5), (A-22)+(S2-6), (A-22)+(S2-7), (A-22)+(S2-8), (A-22)+(S2-9), (A-22)+(S3-1), (A-22)+(S3-2), (A-22)+(S3-3), (A-22)+(S3-4), (A-22)+(S3-5), (A-22)+(54-1), (A-22)+(S4-2), (A-22)+(S4-3), (A-22)+(S4-4); (A-22)+(S5-1);
(A-23) (S1-1), (A-23)+(S1-2), (A-23)+(S1-3), (A-23)+(S1-4), (A-23)+(S1-5), (A-23)+(S1-6), (A-23)+(S1-7), (A-23)+(S1-8), (A-23)+(S1-9), (A-23)+(S1-10), (A-23)+(S1-11), (A-23)+(S2-1), (A-23)+(S2-2), (A-23)+(S2-3), (A-23)+(S2-4), (A-23)+(S2-5), (A-23)+(S2-6), (A-23)+(S2-7), (A-23)+(S2-8), (A-23)+(S2-9), (A-23)+(S3-1), (A-23)+(S3-2), (A-23)+(S3-3), (A-23)+(S3-4), (A-23)+(S3-5), (A-23)+(54-1), (A-23)+(S4-2), (A-23)+(S4-3), (A-23)+(S4-4); (A-23)+(S5-1);
(A-24)+(S1-1), (A-24)+(S1-2), (A-24)+(S1-3), (A-24)+(S1-4), (A-24)+(S1-5), (A-24)+(S1-6), (A-24)+(S1-7), (A-24)+(S1-8), (A-24)+(S1-9), (A-24)+(S1-10), (A-24)+(S1-11), (A-24)+(S2-1), (A-24)+(S2-2), (A-24)+(S2-3), (A-24)+(S2-4), (A-24)+(S2-5), (A-24)+(S2-6), (A-24)+(S2-7), (A-24)+(S2-8), (A-24)+(S2-9), (A-24)+(S3-1), (A-24)+(S3-2), (A-24)+(S3-3), (A-24)+(S3-4), (A-24)+(S3-5), (A-24)+(S4-1), (A-24)+(S4-2), (A-24)+(S4-3), (A-24)+(S4-4); (A-24)+(S5-1);
(A-25) (S1-1), (A-25)+(S1-2), (A-25) (S1-3), (A-25)+(S1-4), (A-25)+(S1-5), (A-25)+(S1-6), (A-25) (S1-7), (A-25)+(S1-8), (A-25)+(S1-9), (A-25)+(S1-10), (A-25)+(S1-11), (A-25)+(S2-1), (A-25)+(S2-2), (A-25)+(S2-3), (A-25)+(S2-4), (A-25)+(S2-5), (A-25)+(S2-6), (A-25)+(S2-7), (A-25)+(S2-8), (A-25)+(S2-9), (A-25)+(S3-1), (A-25)+(S3-2), (A-25)+(S3-3), (A-25)+(S3-4), (A-25)+(S3-5), (A-25)+(S4-1), (A-25)+(54-2), (A-25)+(S4-3), (A-25)+(S4-4); (A-25)+(S5-1);
(A-26)+(S1-1), (A-26)+(S1-2), (A-26)+(S1-3), (A-26)+(S1-4), (A-26)+(S1-5), (A-26)+(S1-6), (A-26)+(S1-7), (A-26)+(S1-8), (A-26)+(S1-9), (A-26)+(S1-10), (A-26)+(S1-11), (A-26)+(S2-1), (A-26)+(S2-2), (A-26)+(S2-3), (A-26)+(S2-4), (A-26)+(S2-5), (A-26)+(S2-6), (A-26)+(S2-7), (A-26)+(S2-8), (A-26)+(S2-9), (A-26)+(S3-1), (A-26)+(S3-2), (A-26)+(S3-3), (A-26)+(S3-4), (A-26)+(S3-5), (A-26)+(S4-1), (A-26)+(S4-2), (A-26)+(S4-3), (A-26)+(S4-4); (A-26)+(S5-1);
(A-27)+(S1-1), (A-27)+(S1-2), (A-27)+(S1-3), (A-27)+(S1-4), (A-27)+(S1-5), (A-27)+(S1-6), (A-27)+(S1-7), (A-27)+(S1-8), (A-27)+(S1-9), (A-27)+(S1-10), (A-27)+(S1-11), (A-27)+(S2-1), (A-27)+(S2-2), (A-27)+(S2-3), (A-27)+(S2-4), (A-27)+(S2-5), (A-27)+(S2-6), (A-27)+(S2-7), (A-27)+(S2-8), (A-27)+(S2-9), (A-27)+(S3-1), (A-27)+(S3-2), (A-27)+(S3-3), (A-27)+(S3-4), (A-27)+(S3-5), (A-27)+(S4-1), (A-27)+(S4-2), (A-27)+(S4-3), (A-27)+(S4-4); (A-27)+(S5-1);
(A-28)+(S1-1), (A-28)+(S1-2), (A-28)+(S1-3), (A-28)+(S1-4), (A-28)+(S1-5), (A-28)+(S1-6), (A-28)+(S1-7), (A-28)+(S1-8), (A-28)+(S1-9), (A-28)+(S1-10), (A-28)+(S1-11), (A-28)+(S2-1), (A-28)+(S2-2), (A-28)+(S2-3), (A-28) (S2-4), (A-28)+(S2-5), (A-28)+(S2-6), (A-28)+(S2-7), (A-28)+(S2-8), (A-28)+(S2-9), (A-28)+(53-1), (A-28)+(S3-2), (A-28)+(S3-3), (A-28)+(S3-4), (A-28)+(S3-5), (A-28)+(S4-1), (A-28)+(S4-2), (A-28)+(S4-3), (A-28)+(S4-4); (A-28)+(55-1);
(A-29)+(S1-1), (A-29)+(S1-2), (A-29)+(S1-3), (A-29)+(S1-4), (A-29)+(S1-5), (A-29)+(S1-6), (A-29)+(S1-7), (A-29)+(S1-8), (A-29)+(S1-9), (A-29)+(51-10), (A-29)+(S1-11), (A-29)+(S2-1), (A-29)+(S2-2), (A-29)+(S2-3), (A-29)+(S2-4), (A-29)+(S2-5), (A-29)+(S2-6), (A-29)+(S2-7), (A-29)+(S2-8), (A-29)+(S2-9), (A-29)+(S3-1), (A-29)+(S3-2), (A-29)+(S3-3), (A-29)+(33-4), (A-29)+(S3-5), (A-29)+(S4-1), (A-29)+(S4-2), (A-29)+(S4-3), (A-29)+(S4-4); (A-29)+(S5-1);
(A-30)+(S1-1), (A-30)+(S1-2), (A-30)+(S1-3), (A-30)+(S1-4), (A-30)+(S1-5), (A-30)+(S1-6), (A-30)+(31-7), (A-30)+(S1-8), (A-30)+(S1-9), (A-30)+(S1-10), (A-30)+(S1-11), (A-30)+(S2-1), (A-30)+(S2-2), (A-30)+(S2-3), (A-30)+(S2-4), (A-30)+(S2-5), (A-30)+(S2-6), (A-30)+(S2-7), (A-30)+(S2-8), (A-30)+(S2-9), (A-30)+(S3-1), (A-30)+(S3-2), (A-30)+(S3-3), (A-30)+(S3-4), (A-30)+(S3-5), (A-30)+(S4-1), (A-30)+(S4-2), (A-30)+(S4-3), (A-30)+(S4-4); (A-30)+(S5-1);
(A-31)+(S1-1), (A-31)+(S1-2), (A-31)+(S1-3), (A-3 (S1-4), (A-31)+(S1-5), (A-31)+(S1-6), (A-31)+(S1-7), (A-31)+(S1-8), (A-31)+(S1-9), (A-31)+(51-10), (A-31)+(S1-11), (A-31)+(S2-1), (A-31)+(S2-2), (A-31)+(S2-3), (A-31)+(S2-4), (A-31)+(S2-5), (A-31)+(S2-6), (A-31)+(S2-7), (A-31)+(S2-8), (A-31)+(S2-9), (A-31)+(S3-1), (A-31)+(S3-2), (A-31)+(S3-3), (A-31)+(S3-4), (A-31)+(33-5), (A-31)+(S4-1), (A-31)+(S4-2), (A-31)+(S4-3), (A-31)+(S4-4); (A-31)+(S5-1);
(A-32)+(S1-1), (A-32)+(S1-2), (A-32)+(S1-3) (A-32)+(51-4), (A-32)+(S1-5), (A-32)+(S1-6), (A-32)+(S1-7), (A-32)+(S1-8), (A-32)+(S1-9), (A-32)+(51-10), (A-32)+(S1-11), (A-32)+(S2-1), (A-32)+(S2-2), (A-32)+(S2-3), (A-32)+(S2-4), (A-32)+(S2-5), (A-32)+(S2-6), (A-32)+(S2-7), (A-32)+(S2-8), (A-32)+(S2-9), (A-32)+(S3-1), (A-32)+(S3-2), (A-32)+(S3-3), (A-32)+(S3-4), (A-32)+(S3-5), (A-32) (S4-1), (A-32)+(S4-2), (A-32)+(S4-3), (A-32)+(S4-4); (A-32) (S5-1);
(A-33)+(S1-1), (A-33)+(51-2), (A-33)+(S1-3), (A-33)+(S1-4), (A-33)+(S1-5), (A-33)+(S1-6), (A-33)+(S1-7), (A-33)+(S1-8), (A-33)+(S1-9), (A-33)+(S1-10), (A-33)+(S1-11), (A-33)+(S2-1), (A-33)+(S2-2), (A-33)+(S2-3), (A-33)+(S2-4), (A-33)+(S2-5), (A-33)+(S2-6), (A-33)+(S2-7), (A-33)+(S2-8), (A-33)+(S2-9), (A-33)+(S3-1), (A-33)+(S3-2), (A-33)+(53-3), (A-33)+(S3-4), (A-33)+(S3-5), (A-33)+(S4-1), (A-33)+(S4-2), (A-33)+(S4-3), (A-33)+(S4-4); (A-33)+(S5-1);
(A-34)+(S1-1), (A-34)+(S1-2), (A-34)+(S1-3), (A-34)+(S1-4), (A-34)+(S1-5), (A-34)+(S1-6), (A-34)+(S1-7), (A-34)+(S1-8), (A-34)+(S1-9), (A-34)+(S1-10), (A-34)+(S1-11), (A-34)+(S2-1), (A-34)+(S2-2), (A-34)+(S2-3), (A-34)+(S2-4), (A-34)+(S2-5), (A-34)+(S2-6), (A-34)+(S2-7), (A-34)+(S2-8), (A-34)+(S2-9), (A-34)+(S3-1), (A-34)+(S3-2), (A-34)+(S3-3), (A-34)+(S3-4), (A-34)+(S3-5), (A-34)+(S4-1), (A-34)+(S4-2), (A-34)+(S4-3), (A-34)+(S4-4); (A-34)+(S5-1);
(A-35)+(S1-1), (A-35)+(S1-2), (A-35)+(S1-3), (A-35)+(S1-4), (A-35)+(S1-5), (A-35)+(S1-6), (A-35)+(51-7), (A-35)+(S1-8), (A-35)+(S1-9), (A-35)+(S1-10), (A-35)+(S1-11), (A-35)+(S2-1), (A-35)+(S2-2), (A-35)+(S2-3), (A-35)+(S2-4), (A-35)+(S2-5), (A-35)+(S2-6), (A-35)+(S2-7), (A-35)+(S2-8), (A-35)+(S2-9), (A-35)+(S3-1), (A-35)+(S3-2), (A-35)+(S3-3), (A-35)+(S3-4), (A-35)+(S3-5), (A-35)+(S4-1), (A-35)+(S4-2), (A-35)+(S4-3), (A-35)+(S4-4); (A-35)+(S5-1);

Preferred combinations of herbicidally active compounds (A) as listed in table A, or the herbicidal active compound A-0 and safeners (B) are those in which the safener (B) is selected from the group of safeners consisting of the compounds S1-1 (=mefenpyr-diethyl), S1-9 (=isoxadifen-ethyl), S2-1 (=chloquintocet-mexyl), S3-1 (=cyprosulfamide), Benoxacor, Furilazole, Fluxofenim, S1-6 (fenchlorazole-ethyl); very particularly preferred safeners (B) are the compounds S1-1 (=mefenpyr-diethyl) and S3-1 (cyprosulfamide).

Particularly preferred combinations of herbicidally active compounds (A) as listed in table A, or the herbicidal active compound A-0 and safeners (B) are those in which the safener (B) is selected from the group of safeners consisting of the compounds S1-1 (=mefenpyr-diethyl), S1-9 (=isoxadifen-ethyl), S2-1 (=chloquintocet-mexyl), S3-1 (=cyprosulfamide); very particularly preferred safeners (S) are the compounds S1-1 (=mefenpyr-diethyl) and S3-1 (cyprosulfamide).

Particularly preferred for use in rice is S1-9 (=isoxadifen-ethyl). Particularly preferred for use in cereals is S1-1 (=mefenpyr-diethyl), S2-1 (=cloquintocet-mexyl) and S3-1 (=cyprosulfamide), in corn in particular S1-9 (=isoxadifen-ethyl) and S3-1 (cyprosulfamide). S1-9 (=isoxadifen-ethyl) is preferred for use in sugar cane.

The safeners (group B compounds) of the formulae (S-1)-(S-XII) are suitable for reducing phytotoxic effects which may occur when herbicides (A) are used in crops of useful plants, while having no major adverse effect on the activity of these herbicidal active compounds against harmful plants. By virtue of these properties, it is possible to extend the field of application of customary crop protection compositions considerably, for example to crops in which it has hitherto been possible not to employ the herbicides at all or to employ them only to a limited extent.

Depending on indication and herbicidal active compound used, the required application rates of the safeners can vary within wide limits and are generally in the range from 1 to 5000 g, preferably from 5 to 2500 g, of active compound per hectare.

The herbicidal active compounds (A) and the safeners (B) can be applied together (for example as a ready mix or by the tank mix method) or sequentially in any desired order, for example by atomizing, pouring or spraying, or by broadcasting granules. The weight ratio of herbicide (A): safener (B) may vary within wide limits and is preferably in the range from 1:10 000 to 10 000:1, in particular from 1:5000 to 5000:1 and very particularly preferably from 1:1000 to 1000:1. The optimum amounts of herbicide and safener depend in each case on the type of herbicide used and the type of safener used and on the nature and the development stage of the plant stock to be treated and can be determined in each individual case by simple routine preliminary experiments.

Depending on their properties, the safeners (B) contained in the herbicide/safener combination according to the invention can be used for pretreating the seed of the crop plant (for example for seed dressing) or introduced into the seed furrows prior to sowing or used together with the herbicide before or after emergence of the plants. Pre-emergence treatment includes not only the treatment of the area under cultivation (including, if appropriate, water present on the area under cultivation, for example in the case of rice applications) before sowing, but also the treatment of the sown soil which does not yet sustain vegetation. Preferred is the application together with the herbicide. Tank mixes or ready mixes may be employed for this purpose.

In a preferred embodiment, the seed (for example grains, seed or vegetative propagation organs, such as tubers or shoot parts with buds) or seedlings are pretreated with the safeners (B), if appropriate in combination with other agrochemically active compounds. For pretreating the seed, the active compounds can be applied to the seed, for example, by dressing, or the active compounds and the seed can be introduced into water or other solvents, and the active compounds can be taken up, for example, by adduct formation or diffusion in a dip process or by swelling or pregermination. For the pretreatment of seedlings, the young plants can be brought into contact with the safeners, if appropriate in combination with other agrochemically active compounds, for example by spraying, dipping or watering, and then be transplanted and, if appropriate, be subjected to a post-treatment with the herbicides (A).

The treatment of the seed or the seedlings can be carried out using the safeners (B) alone or together with other agrochemically active compounds, such as fungicides, insecticides or agents for fortifying the plant, for fertilizing or for promoting the swelling and germination processes. Here, the safeners may, after the pretreatment application, be applied once more before, after or together with one or more herbicides (A) optionally also in combination with other known herbicides. By pretreating the seed or the seedlings, it is possible to achieve better long-term action of the safeners.

Accordingly, the present invention also provides a method for controlling unwanted plants in crops of plants, which method comprises applying the components (A) and (B) of the herbicide/safener combination according to the invention to the plants (for example harmful plants, such as monocotyledonous or dicotyledonous weeds or unwanted crop plants), the seed (for example grains, seeds or vegetative propagation organs, such as tubers or shoot parts with buds) or to the area on which the plants grow (for example the area under cultivation), for example jointly or separately. Here, it is possible to apply one or more safeners (B), preferably one or more, in particular one, compound of the formula (S-1) to (S-XII) and/or from the group B, before, after or simultaneously with the herbicide(s) (A) to the plants, the seed or the area in which the plants grow (for example the area under cultivation). In a preferred embodiment, the safeners (B) are used for treating the seed.

Unwanted plants are to be understood as meaning all plants growing in locations where they are unwanted. These may be, for example, harmful plants (for example monocotyledonous or dicotyledonous weeds or unwanted crop plants), including, for example, those which are resistant to certain herbicidal active compounds, such as glyphosate, atrazine, glufosinate or imidazolinone herbicides.

Examples of weed species on which the herbicidal compositions act efficiently are, from amongst the monocotyledonous weed species, Avena spp., Alopecurus spp., Apera spp., Brachiaria spp., Bromus spp., Digitaria spp., Lolium spp., Echinochloa spp., Panicum spp., Phalaris spp., Poa spp., Setaria spp. and also Cyperus species from the annual group, and, among the perennial species, Agropyron, Cynodon, Imperata and Sorghum and also perennial Cyperus species.

In the case of the dicotyledonous weed species, the spectrum of action extends to genera such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., among the annuals, and Convolvulus, Cirsium, Rumex and Artemisia in the case of the perennial weeds.

In the process according to the invention, preferably an effective amount of the components (A) and (B) is used for controlling harmful plants in crop plants, for example in economically important arable crops, for example monocotyledonous arable crops, such as cereals (for example wheat, barley, rye, oats), rice, corn, millet, or dicotyledonous arable crops, such as sugar beet, oilseed rape, cotton, sunflowers and leguminous plants, for example of the genera Glycine (for example Glycine max., such as non-transgenic Glycine max. (for example conventional cultivars, such as STS cultivars) or transgenic Glycine max. (for example RR soybeans or LL soybeans) and crossbreeds thereof), Phaseolus, Pisum, Vicia and Arachis, or vegetable crops of various botanical groups, such as potato, leek, cabbage, carrot, tomato, onion, and also permanent crops and plantation crops, such as pomaceous fruit and stone fruit, soft fruit, grapevines, Hevea, bananas, sugar cane, coffee, tea citrus plants, nut plantations, lawn, palm plantations and forest plantations.

The invention also provides for the use of the herbicide/safener combinations according to the invention for controlling unwanted vegetation, preferably in crop plants.

The herbicide/safener combinations according to the invention can be prepared by known processes, for example as mix formulations of the individual components, if appropriate with further active compounds, additives and/or customary formulation auxiliaries, which are then applied in a customary manner diluted with water, or they can be prepared as tank mixes by jointly diluting the individual components, formulated separately or partially formulated separately, with water. It is furthermore possible to apply the individual components, formulated separately or partially formulated separately, at different times (splitting). It is also possible to apply the individual components or the herbicide/safener combinations in a plurality of portions (sequential application), for example pre-emergence applications followed by post-emergence applications or early post-emergence applications followed by medium or late post-emergence applications. Preference is given here to the joint or almost simultaneous application of the active compounds of the combination in question.

The herbicide/safener combination according to the invention can also be employed for controlling harmful plants in crops of known genetically modified plants or genetically modified plants or those yet to be developed. In general, the transgenic plants have particular advantageous properties, for example resistance to certain crop protection agents, resistance to plant diseases or to causative agents of plant diseases, such as specific insects or microorganisms, such as fungi, bacteria or viruses. Other particular properties are concerned, for example, with the harvested crop with regard to quantity, quality, storability, composition and specific constituents. Thus, transgenic plants are known which have an increased starch content or a modified starch quality, or which have a different fatty acid composition or amino acid composition of the harvested crop.

Preference is given to the use of the combinations according to the invention in economically important transgenic crops of useful plants and ornamentals, for example of cereals (such as wheat, barley, rye, oats), millet, rice, cassaya and corn, or else crops of sugar cane, sugar beet, cotton, soybean, oilseed rape, potato, tomato, pea and other vegetables.

When the combinations according to the invention are used in transgenic crops, effects in addition to the effects to be observed against harmful plants in other crops are frequently found, which are specific for application in the particular transgenic crop, for example a modified or specifically widened spectrum of weeds which can be controlled, modified application rates which may be employed for the application, preferably good combinability with the herbicides to which the transgenic crop is resistant, and an effect on growth and yield of the transgenic crop plants.

Accordingly, the invention also provides for the use of the herbicidally active composition according to the invention for controlling harmful plants in transgenic crop plants or crop plants which are tolerant as a result of selective breeding.

The herbicides (A) and the safeners (B) can, together or separately, be converted into customary formulations, for example for application by atomizing, watering, spraying and seed dressing, such as solutions, emulsions, suspensions, powders, foams, pastes, granules, aerosols, natural compounds or synthetic materials impregnated with active compounds, microcapsules in polymeric compounds. The formulations may comprise the customary auxiliaries and additives.

These formulations are produced in a known manner, for example by mixing the active compounds with extenders, that is liquid solvents, pressurized liquefied gases and/or solid carriers, if appropriate with the use of surfactants, that is emulsifiers and/or dispersants, and/or foam formers.

If the extender used is water, it is also possible to use, for example, organic solvents as auxiliary solvents. Suitable liquid solvents are essentially: aromatics, such as xylene, toluene, alkylnaphthalenes, chlorinated aromatics or chlorinated aliphatic hydrocarbons, such as chlorobenzenes, chloroethylenes, or methylene chloride, aliphatic hydrocarbons, such as cyclohexane or paraffins, for example mineral oil fractions, mineral and vegetable oils, alcohols, such as butanol or glycol, and ethers and esters thereof, ketones, such as acetone, methyl ethyl ketone, methyl isobutyl ketone or cyclohexanone, strongly polar solvents, such as dimethylformamide or dimethyl sulfoxide, and also water.

Suitable solid carriers are: for example ammonium salts and ground natural minerals, such as kaolins, clays, talc, chalk, quartz, attapulgite, montmorillonite or diatomaceous earth, and ground synthetic minerals, such as finely divided silica, alumina and silicates; suitable solid carriers for granules are: for example crushed and fractionated natural rocks, such as calcite, marble, pumice, sepiolite and dolomite, and also synthetic granules of inorganic and organic meals, and granules of organic material, such as sawdust, coconut shells, corn cobs and tobacco stalks; suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates and also protein hydrolysates; suitable dispersants are: for example lignosulfite waste liquors and methylcellulose.

Tackifiers such as carboxymethylcellulose and natural and synthetic polymers in the form of powders, granules or latices, such as gum arabic, polyvinyl alcohol and polyvinyl acetate, and also natural phospholipids, such as cephalins and lecithins and synthetic phospholipids, can be used in the formulations. Other possible additives are mineral and vegetable oils.

The herbicidal action of the herbicide/safener combination according to the invention can be equally improved, for example, by surfactants, preferably by wetting agents from the group of the fatty alcohol polyglycol ethers. The fatty alcohol polyglycol ethers preferably comprise 10-18 carbon atoms in the fatty alcohol radical and 2-20 ethylene oxide units in the polyglycol ether moiety. The fatty alcohol polyglycol ethers may be present in nonionic form, or ionic form, for example in the form of fatty alcohol polyglycol ether sulfates, which may be used, for example, as alkali metal salts (for example sodium salts and potassium salts) or ammonium salts, or even as alkaline earth metal salts, such as magnesium salts, such as C₁₂/C₁₄-fatty alcohol diglycol ether sulfate sodium (Genapol® LRO, Clariant GmbH); see, for example, EP-A-0476555, EP-A-0048436, EP-A-0336151 or U.S. Pat. No. 4,400,196 and also Proc. EWRS Symp. “Factors Affecting Herbicidal Activity and Selectivity”, 227-232 (1988). Nonionic fatty alcohol polyglycol ethers are, for example, (C₁₀-C₁₈)-, preferably (C₁₀-C₁₄)-fatty alcohol polyglycol ethers (for example isotridecyl alcohol polyglycol ethers) which comprise, for example, 2-20, preferably 3-15, ethylene oxide units, for example those from the Genapol® X-series, such as Genapol® X-030, Genapol® X-060, Genapol® X-080 or Genapol® X-150 (all from Clariant GmbH).

The present invention further comprises the combination of components A and B with the wetting agents mentioned above from the group of the fatty alcohol polyglycol ethers which preferably contain 10-18 carbon atoms in the fatty alcohol radical and 2-20 ethylene oxide units in the polyglycol ether moiety and which may be present in nonionic or ionic form (for example as fatty alcohol polyglycol ether sulfates). Preference is given to C₁₂/C₁₄-fatty alcohol diglycol ether sulfate sodium (Genapol® LRO, Clariant GmbH) and isotridecyl alcohol polyglycol ether having 3-15 ethylene oxide units, for example from the Genapol® X-series, such as Genapol® X-030, Genapol® X-060, Genapol® X-080 and Genapol® X-150 (all from Clariant GmbH). Furthermore, it is known that fatty alcohol polyglycol ethers, such as nonionic or ionic fatty alcohol polyglycol ethers (for example fatty alcohol polyglycol ether sulfates) are also suitable for use as penetrants and activity enhancers for a number of other herbicides (see, for example, EP-A-0502014).

Furthermore, it is known that fatty alcohol polyglycol ethers, such as nonionic or ionic fatty alcohol polyglycol ethers (for example fatty alcohol polyglycol ether sulfates) are also suitable for use as penetrants and activity enhancers for a number of other herbicides (see, for example, EP-A-0502014).

The herbicidal action of the herbicide/safener combinations according to the invention can also be enhanced by using vegetable oils. The term vegetable oils is to be understood as meaning oils of oleaginous plant species, such as soybean oil, rapeseed oil, corn oil, sunflower oil, cottonseed oil, linseed oil, coconut oil, palm oil, thistle oil or castor oil, in particular rapeseed oil, and also their transesterification products, for example alkyl esters, such as rapeseed oil methyl ester or rapeseed oil ethyl ester.

The vegetable oils are preferably esters of C₁₀-C₂₂-, preferably C₁₂-C₂₀-, fatty acids. The C₁₀-C₂₂-fatty acid esters are, for example, esters of unsaturated or saturated C₁₀-C₂₂-fatty acids, in particular those having an even number of carbon atoms, for example erucic acid, lauric acid, palmitic acid and in particular C₁₈-fatty acids, such as stearic acid, oleic acid, linoleic acid or linolenic acid.

Examples of C₁₀-C₂₂-fatty acid esters are esters obtained by reacting glycerol or glycol with the C₁₀-C₂₂-fatty acids contained, for example, in oils of oleaginous plant species, or C₁-C₂₀-alkyl-C₁₀-C₂₂-fatty acid esters which can be obtained, for example, by transesterification of the aforementioned glycerol- or glycol-C₁₀-C₂₂-fatty acid esters with C₁-C₂₀-alcohols (for example methanol, ethanol, propanol or butanol). The transesterification can be carried out by known methods as described, for example, in Römpp Chemie Lexikon, 9th edition, Volume 2, page 1343, Thieme Verlag Stuttgart.

Preferred C₁-C₂₀-alkyl-C₁₀-C₂₂-fatty acid esters are methyl esters, ethyl esters, propyl esters, butyl esters, 2-ethylhexyl esters and dodecyl esters. Preferred glycol- and glycerol-C₁₀-C₂₂-fatty acid esters are the uniform or mixed glycol esters and glycerol esters of C₁₀-C₂₂-fatty acids, in particular fatty acids having an even number of carbon atoms, for example erucic acid, lauric acid, palmitic acid and, in particular, C₁₈-fatty acids, such as stearic acid, oleic acid, linoleic acid or linolenic acid.

In the herbicide/safener combinations according to the invention, the vegetable oils can be present, for example, in the form of commercially available oil-containing formulation additives, in particular those based on rapeseed oil, such as Hasten®(Victorian Chemical Company, Australia, hereinbelow referred to as Hasten, main ingredient: rapeseed oil ethyl ester), Actirob®^{B} (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

In a further embodiment, the present invention comprises combinations with the vegetable oils mentioned above, such as rapeseed oil, preferably in the form of commercially available oil-containing formulation additives, in particular those based on rapeseed oil, such as Hasten® (Victorian Chemical Company, Australia, hereinbelow referred to as Hasten, main ingredient: rapeseed oil ethyl ester), Actirob®B (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

It is possible to use colorants, such as inorganic pigments, for example iron oxide, titanium oxide, Prussian Blue, and organic dyes, such as alizarin dyes, azo dyes and metal phthalocyanine dyes, and trace nutrients such as salts of iron, manganese, boron, copper, cobalt, molybdenum and zinc.

The formulations generally comprise from 0.1 to 95% by weight of active compound, preferably from 0.5 to 90% by weight.

As such or in their formulations, the herbicides (A) and the safeners (B) can also be used as a mixture with other agrochemically active compounds, such as known herbicides, for controlling unwanted vegetation, for example for controlling weeds or for controlling unwanted crop plants, finished formulations or tank mixes, for example, being possible.

Mixtures with other known active compounds, such as fungicides, insectides, acaricides, nematicides, safeners, bird repellants, plant nutrients and soil structure improvers are likewise possible, as are mixtures with formulation auxiliaries and additives customary in crop protection.

The herbicides (A) and the safeners (B) can be used as such, in the form of their formulations or in the use forms prepared therefrom by further dilution, such as ready-to-use solutions, suspensions, emulsions, powders, pastes and granules. Application is carried out in a customary manner, for example by watering, spraying, atomizing, broadcasting.

The active compounds can be applied to the plants, plant parts, the seed or the area under cultivation (the soil), preferably to the seed or the green plants and parts of plants and, if appropriate, additionally the soil. One possible use is the joint application of the active compounds in the form of tank mixes, where the optimally formulated concentrated formulations of the individual active compounds are, together, mixed in a tank with water, and the spray liquor obtained is applied.

A joint formulation of the combination according to the invention of active compounds (A) and safeners (B) has the advantage that it is easier to apply, since the amounts of the components are already in optimal ratio. Moreover, the auxiliaries in the formulation can be adjusted optimally to one another.

Possible combination partners for the herbicide/safener combination according to the invention in mixed formulations or in tank mixers are, for example, known agrochemically active compounds, such as herbicides, preferably herbicidally active compounds whose action is based on inhibition of, for example, acetolactate synthase, acetyl coenzyme A carboxylase, PS I, PS II, HPPDO, phytoene desaturase, protoporphyrinogen oxidase, glutamine synthetase, cellulose biosynthesis, 5-enolpyruvylshikimate 3-phosphate synthetase, as described, for example, in Weed Research 26, 441-445 (1986), or “The Pesticide Manual”, 13th edition, The British Crop Protection Council, 2003, or 14^{th} edition 2006/2007, or in the corresponding “e-Pesticide Manual”, Version 4 (2006), in each case published by the British Crop Protection Council, (hereinbelow in short also “PM”), and in the literature cited therein. Lists of common names are also available in “The Compendium of Pesticide Common Names” on the internet. Herbicides known from the literature, which can be combined with 2-iodo-N-[(4-methoxy-6-methyl-1,3,5-triazin-2-yl)carbamoyl]benzenesulfonamide and the compounds of the formula (I), are, for example, the active compounds listed below: (note: the herbicides are referred to either by the “common name” in accordance with the International Organization for Standardization (ISO) or by the chemical name, together where appropriate with a customary code number, and in each case include all use forms, such as acids, salts, esters and isomers, such as stereoisomers and optical isomers, in particular the commercial form or the commercial forms, unless the context indicates otherwise. Sulfonamides, such as sulfonylureas, also include salts formed by exchanging a hydrogen atom at the sulfonamide group for a cation. The citation given is of one use form and in some cases of two or more use forms): acetochlor; acibenzolar-S-methyl; acifluorfen(-sodium); aclonifen; AD-67; AKH 7088, i.e. [[[1-[5-[2-chloro-4-(trifluoromethyl)phenoxy]-2-nitrophenyl]-2-methoxyethylidene]amino]oxy]acetic acid and methyl [[[1-[5-[2-chloro-4-(trifluoromethyl)phenoxy]-2-nitrophenyl]-2-methoxyethylidene]amino]oxy]acetate; alachlor; alloxydim(-sodium); ametryn; amicarbazone, amidochlor, amidosulfuron; aminopyralid; amitrol; ammonium pelargonate; AMS, i.e. ammonium sulfamate; ancimidol; anilofos; asulam; atrazine; aviglycine; azafenidin, azimsulfuron (DPX-A8947); aziprotryn; barban; BAS 516H, i.e. 5-fluoro-2-phenyl-4H-3,1-benzoxazin-4-one; beflubutamid (UBH-509), benazolin(-ethyl); bencarbazone; benfluralin; benfuresate; bensulfuron(-methyl); bensulide; bentazone; benzfendizone; benzobicyclon, benzofenap; benzofluor; benzoylprop(-ethyl); benzthiazuron; bilanaphos; bifenox; bispyribac(-sodium) (KIN-2023); borax; bromacil; bromobutide; bromofenoxim; bromoxynil; bromuron; buminafos; busoxinone; butachlor; butafenacil; butamifos; butenachlor (KH-218); buthidazole; butralin; butroxydim; butylate; cafenstrole (CH-900); caloxydim; carbetamide; carfentrazone(-ethyl); catechin; CDAA, i.e. 2-chloro-N,N-di-2-propenylacetamide; CDEC, i.e. 2-chloroallyl diethyldithiocarbamate; chlormesulon; chlomethoxyfen; chloramben; chlorazifop-butyl; chlorbromuron; chlorbufam; chlorfenac; chlorfenprop; chlorflurecol(-methyl); chlorflurenol(-methyl); chloridazon; chlorimuron(-ethyl); chlormequat chloride; chlornitrofen; chlorophthalim (MK-616); chlorotoluron; chloroxuron; chlorpropham; chlorsulfuron; chlorthal-dimethyl; chlorthiamid; chlortoluron; cinidon(-methyl and -ethyl); cinmethylin; cinosulfuron; clefoxydim; clethodim; clodinafop and its ester derivatives (for example clodinafop-propargyl); clofencet; clomazone; clomeprop; cloprop; cloproxydim; clopyralid; clopyrasulfuron(-methyl); cloransulam(-methyl); cumyluron (JC 940); cyanamide; cyanazine; cycloate; cyclosulfamuron (AC 104); cycloxydim; cycluron; cyhalofop and its ester derivatives (for example the butylester, DEH-112); cyperquat; cyprazine; cyprazole; daimuron; 2,4-D; 2,4-DB; dalapon; daminozide; dazomet; n-decanol; desmedipham; desmetryn; di-allate; dicamba; dichlobenil; dichlormid; dichlorprop(-P) salts; diclofop and its esters, such as diclofop-methyl; diclofop-P(-methyl); diclosulam; diethatyl(-ethyl); difenoxuron; difenzoquat (metil sulfate); diflufenican; diflufenzopyr(-sodium); dimefuron; dimepiperate; dimethachlor; dimethametryn; dimethazone; dimethenamid (SAN-582H); dimethenamide-P; dimethylarsinic acid; dimethipin; dimetrasulfuron; dimexyflam; dinitramine; dinoseb; dinoterb; diphenamid; dipropetryn; diquat salts; dithiopyr; diuron; DNOC; eglinazine-ethyl; EL 77, i.e. 5-cyano-1-(1,1-dimethylethyl)-N-methyl-1H-pyrazole-4-carboxamide; endothal; epoprodan; EPTC; esprocarb; ethalfluralin; ethametsulfuron-methyl; ethephon; ethidimuron; ethiozin; ethofumesate; ethoxyfen and its esters (for example the ethyl ester, HN-252); ethoxysulfuron; etobenzanid (HW 52); F5231, i.e. N-[2-chloro-4-fluoro-5-[4-(3-fluoropropyl)-4,5-dihydro-5-oxo-1H-tetrazol-1-yl]phenyl]-ethanesulfonamide; fenchlorazole(-ethyl); fenclorim; fenoprop; fenoxan, fenoxaprop and fenoxaprop-P and their esters, for example fenoxaprop-P-ethyl and fenoxaprop-ethyl; fenoxydim; fentrazamide; fenuron; ferrous sulfate; flamprop(-methyl or -isopropyl or -isopropyl-L); flamprop-M(-methyl or -isopropyl); flazasulfuron; floazulate (JV-485); florasulam; fluazifop and fluazifop-P and their esters, for example fluazifop-butyl and fluazifop-P-butyl; fluazolate; flucarbazone(-sodium); flucetosulfuron; fluchloralin; flufenacet; flufenpyr(-ethyl); flumetralin; flumetsulam; flumeturon; flumiclorac(-pentyl); flumioxazin (S-482); flumipropyn; fluometuron; fluorochloridone; fluorodifen; fluoroglycofen(-ethyl); flupoxam (KNW-739); flupropacil (UBIC-4243); flupropanoate; flupyrsulfuron(-methyl)(-sodium); flurenol(-butyl); fluridone; fluorochloridone; fluoroxypyr(-meptyl); flurprimidol; flurtamone; fluthiacet(-methyl) (KIH-9201); fluthiamide; fluxofenim; fomesafen; foramsulfuron; forchlorfenuron; fosamine; furyloxyfen; gibberillic acid; glufosinate(-ammonium); glyphosate(-isopropylammonium); halosafen; halosulfuron(-methyl); haloxyfop and its ester; haloxyfop-P (=R-haloxyfop) and its ester; HC-252; hexazinone; HNPC-C9908, i.e. methyl 2-[[[[[4-methoxy-6-(methylthio)-2-pyrimidinyl]amino]carbonyl]amino]sulfonyl]benzoate; imazamethabenz(-methyl); imazamox; imazapic; imazapyr; imazaquin and salts, such as the ammonium salt; imazethapyr; imazosulfuron; inabenfide; indanofan; iodosulfuron-methyl(-sodium); ioxynil; isocarbamid; isopropalin; isoproturon; isouron; isoxaben; isoxachlortole; isoxaflutole; isoxapyrifop; karbutilate; lactofen; lenacil; linuron; maleic hydrazide (MH); MBTA; MCPA; MCPB; mecoprop(-P); mefenacet; mefluidide; mepiquat (chloride); mesosulfuron (methyl); mesotrione; metam; metamifop; metamitron; metazachlor; methabenzthiazuron; metham; methazole; methoxyphenone; methylarsonic acid; methyl-cyclopropene; methyldymron; methyl isothiocyanate; methabenzthiazuron; metobenzuron; metobromuron; (alpha-)-metolachlor; metosulam (XRD 511); metoxuron; metribuzin; metsulfuron-methyl; molinate; monalide; monocarbamide dihydrogensulfate; monolinuron; monuron; monosulfuron; MT 128, i.e. 6-chloro-N-(3-chloro-2-propenyl)-5-methyl-N-phenyl-3-pyridazinamine; MT 5950, i.e. N-[3-chloro-4-(1-methylethyl)phenyl]-2-methylpentanamide; naproanilide; napropamide; naptalam; NC 310, i.e. 4-(2,4-dichlorobenzoyl)-1-methyl-5-benzyloxypyrazole; neburon; nicosulfuron; nipyraclofen; nitralin; nitrofen; nitrophenolate mixture; nitrofluorfen; nonanoic acid; norflurazon; orbencarb; orthosulfamuron; oxabetrinil; oryzalin; oxadiargyl (RP-020630); oxadiazon; oxasulfuron; oxaziclomefone; oxyfluorfen; paclobutrazol; paraquat(-dichloride); pebulate; pelargonic acid; pendimethalin; penoxulam; pentachlorophenol; pentanochior; pentoxazone; perfluidone; pethoxamid; phenisopham; phenmedipham; picloram; picolinafen; pinoxaden; piperophos; piributicarb; pirifenop-butyl; pretilachlor; primisulfuron(-methyl); probenazole; procarbazone(-sodium); procyazine; prodiamine; profluralin; profoxydim; prohexadione(-calcium); prohydrojasmon; proglinazine(-ethyl); prometon; prometryn; propachlor; propanil; propaquizafop and its esters; propazine; propham; propisochlor; propoxycarbazone(-sodium) (MKH-6561); propyzamide; prosulfalin; prosulfocarb; prosulfuron (CGA-152005); prynachlor; pyraclonil; pyraflufen(-ethyl) (ET-751); pyrasulfotole; pyrazolynate; pyrazon; pyrazosulfuron(-ethyl); pyrazoxyfen; pyribambenz-isopropyl (ZJ 0702); pyrimbambenz-propyl (ZJ 0273); pyribenzoxim; pyributicarb; pyridafol; pyridate; pyriftalid; pyriminobac(-methyl) (KIH-6127); pyrimisulfan (KIN-5996); pyrithiobac(-sodium) (KIH-2031); pyroxasulfone (KIH-485); pyroxofop and its esters (for example the propargyl ester); pyroxsulam; quinclorac; quinmerac; quinoclamine; quinofop and its ester derivatives, quizalofop and quizalofop-P and their ester derivatives, for example quizalofop-ethyl; quizalofop-P-tefuryl and -ethyl; renriduron; rimsulfuron (DPX-E 9636); S 275, i.e. 2-[4-chloro-2-fluoro-5-(2-propynyloxy)phenyl]-4,5,6,7-tetrahydro-2H-indazole; secbumeton; sethoxydim; siduron; simazine; simetryn; sintofen; SN 106279, i.e. 2-[[7-[2-chloro-4-(trifluoromethyl)phenoxy]-2-naphthalenyl]oxy]propanoic acid and methyl 2-[[7-[2-chloro-4-(trifluoromethyl)phenoxy]-2-naphthalenyl]oxy]propanoate; sulcotrione; sulfentrazone (FMC-97285, F-6285); sulfazuron; sulfometuron(-methyl); sulfosate (ICI-A0224); sulfosulfuron; TCA(-sodium); tebutam (GCP-5544); tebuthiuron; tecnacene; tefuryltrione; tembotrione; tepraloxydim; terbacil; terbucarb; terbuchlor; terbu eton; terbuthylazine; terbutryn; TFH 450, i.e. N,N-diethyl-3-[(2-ethyl-6-methylphenyl)sulfonyl]-1H-1,2,4-triazole-1-carboxamide; thenylchlor (NSK-850); thiafluamide, thiazafluoron; thiazopyr (Mon-13200); thidiazimin (SN-24085); thidiazuron; thiencarbazone(-methyl); thifensulfuron(-methyl); thiobencarb; Ti 35; tiocarbazil; topramezone; tralkoxydim; tri-allate; triasulfuron; triaziflam; triazofenamide; tribenuron(-methyl); triclopyr; tridiphane; trietazine; trifloxysulfuron(-sodium); trifluralin; triflusulfuron and esters (for example the methylester, DPX-66037); trimeturon; trinexapac; tritosulfuron; tsitodef; uniconazole; vernolate; WL 110547, i.e. 5-phenoxy-1-[3-(trifluoromethyl)phenyl]-1H-tetrazole; D-489; ET-751; KIH-218; KIH-485; KIH-509; KPP-300; LS 82-556; NC-324, NC-330; DPX-N8189; SC-0774; DOWCO-535; DK-8910; V-53482; PP-600; MBH-001; TH-547; SYN-523; IDH-100; SYP-249, HOK-201; IR-6396, MTB-951, NC-620.

For application, formulations which are present in a commercial form can, if appropriate, be diluted in a customary manner using, for example, water. Preparations in the form of dusts, soil granules and granules for broadcasting and also sprayable solutions are usually not diluted any further with further inert substances prior to the application.

### BIOLOGICAL EXAMPLES

### 1. Pre-Emergence Action Against Weeds

Seeds or rhizome pieces of monocotyledonous and dicotyledonous weed plants were placed in sandy loam soil in cardboard pots and covered with soil. The active compounds (A) and (B), formulated as wettable powders or emulsion concentrates, were then applied to the surface of the covering soil as aqueous suspensions or emulsions in different dosages at a water application rate of 100 to 800 I/ha (converted).

After the treatment, the pots were placed in a greenhouse and kept under good growth conditions for the weeds. Visual scoring of the plant damage or emergence damage was carried out after the test plants had emerged after a test period of 3 to 4 weeks, in comparison to untreated controls. The results show that the tested herbicide combinations have good herbicidal pre-emergence activity against a broad spectrum of weed grasses and broad-leaved weeds. The combinations of 2-iodo-N—[(4-methoxy-6-methyl-1,3,5-triazin-2-yl)carbamoyl]benzenesulfonamide and compounds of the formula (I) mentioned in table A especially with the safeners of the compounds of the formulae S1-1, S1-9, S2-1 and S3-1 have very good synergistic herbicidal activity against harmful plants such as Sinapis alba, Chrysanthemum segetum, Avena sativa, Stellaria media, Echinochloa crus-galli, Lolium multiflorum, Setaria viridis, Abutilon theophrasti, Amaranthus retroflexus and Panicum miliaceum when applied by the pre-emergence method at an application rate of 100 g or less of active substance per hectare.

### 2. Post-Emergence Action Against Weeds

Seeds or rhizome pieces of monocotyledonous and dicotyledonous weeds were placed in sandy loam soil in plastic pots, covered with soil and cultivated in a greenhouse under good growth conditions. Three weeks after sowing, the test plants were treated at the 2- to 4-leaf stage. The compounds according to the invention, formulated as wettable powders or as emulsion concentrates, were sprayed onto the green parts of the plants in various dosages at a water application rate of 100 to 800 I/ha (converted). After the test plants had been left to stand in the greenhouse for 3 to 4 weeks under optimum growth conditions, the effect of the preparations was scored visually in comparison to untreated controls.

In general, the herbicide combinations according to the invention also have good herbicidal post-emergence activity against a broad spectrum of economically important weed grasses and broad-leaved weeds. The combinations of 2-iodo-N-[(4-methoxy-6-methyl-1,3,5-triazin-2-yl)carbamoyl]benzenesulfonamide and compounds of the formula (I) mentioned in table A especially with the safeners of the compounds of the formulae S1-1, S1-9, S2-1 and S3-1 have very good herbicidal activity against harmful plants such as Sinapis alba, Echinochloa crus-galli, Digitaria sanguinalis, Lolium multiflorum, Chrysanthemum segetum, Setaria viridis, Polygonum convolvulus, Abutilon theophrasti, Amaranthus retroflexus, Panicum miliaceum and Avena sativa when applied by the post-emergence method at an application rate of 100 g or less of active substance per hectare.

### 3. Compatibility with Crop Plants

In further greenhouse trials, seeds of a relatively large number of crop plants and weeds were placed into sandy loam soil and covered with soil. Some of the pots were immediately treated as described in section 1, the others were placed in a greenhouse until the plants had developed two to three true leaves and were then sprayed with various dosages of the herbicide/safener combinations according to the invention, as described in section 2. Four to five weeks after the application and standing time in the greenhouse, it was established by visual scoring that the herbicide/safener combinations tested, i.e. of 2-iodo-N-[(4-methoxy-6-methyl-1,3,5-triazin-2-yl)carbamoyl]benzenesulfonamide and the compounds of the formula (I) listed in table A, did, especially with the safeners of the compounds of the formulae S1-1, S1-6, S1-9, S2-1 and S3-1, benoxacor, furilazole, fluxofenim, not cause any damage to crop plants such as cotton, oilseed rape, sugar cane, sugar beet and also Gramineae crops such as barley, wheat, rye, millet, corn or rice when applied by the pre-emergence method or the post-emergence method.

The results of selected trials with respect to the crop plant compatibility are shown below in an exemplary manner using as an example safeners improving 2-iodo-N-[(4-methoxy-6-methyl-1,3,5-triazin-2-yl)carbamoyl]benzenesulfonamide (A-0) or its Na⁺ salt (A-2) in various crop plants, i.e. wheat, barley and corn. However, comparable results can also be obtained on application in other crop plants.

### (a) Post-Emergence Results

TABLE 1
Wheat

| | | Amount of active | Damage to | | Amount of | Damage in the | Reduction of |
|---|---|---|---|---|---|---|---|
| | Active | compound | the crop plant | | safener | presence of the | the damage |
| Crop plant | compound | g of ai/ha | in % | Safener | g of ai/ha | safener in % | in % |
| Wheat | A-0 | 6.25 | 20 | mefenpyrdiethyl | 200 | 10 | 50 |
| Wheat | A-2 | 12.5 | 10 | mefenpyrdiethyl | 200 | 0 | 100 |
| Wheat | A-2 | 25 | 20 | mefenpyrdiethyl | 200 | 0 | 100 |
| Wheat | A-2 | 50 | 30 | mefenpyrdiethyl | 200 | 10 | 67 |
| Wheat | A-0 | 6.25 | 20 | isoxadifenethyl | 200 | 10 | 50 |
| Wheat | A-0 | 6.25 | 20 | cyprosulfamide | 200 | 10 | 50 |
| Wheat | A-0 | 6.25 | 20 | benoxacor | 200 | 10 | 50 |
| Wheat | A-0 | 6.25 | 20 | furilazole | 200 | 0 | 100 |
| Wheat | A-0 | 12.5 | 20 | furilazole | 200 | 0 | 100 |
| Wheat | A-0 | 6.25 | 20 | fluxofenim | 200 | 0 | 100 |
| Wheat | A-0 | 6.25 | 20 | fenchlorazole | 200 | 10 | 50 |

TABLE 2
Barley

| | | Amount of active | Damage to | | Amount of | Damage in the | Reduction of |
|---|---|---|---|---|---|---|---|
| | Active | compound | the crop plant | | safener | presence of the | the damage |
| Crop plant | compound | g of ai/ha | in % | Safener | g of ai/ha | safener in % | in % |
| Barley | A-0 | 12.5 | 20 | isoxadifenethyl | 200 | 10 | 50 |
| Barley | A-0 | 6.25 | 10 | cyprosulfamide | 200 | 0 | 100 |
| Barley | A-0 | 12.5 | 20 | furilazole | 200 | 0 | 100 |
| Barley | A-0 | 6.25 | 20 | furilazole | 200 | 0 | 100 |

TABLE 3
Corn

| | | Amount of active | Damage to | | Amount of | Damage in the | Reduction of |
|---|---|---|---|---|---|---|---|
| | Active | compound | the crop plant | | safener | presence of the | the damage |
| Crop plant | compound | g of ai/ha | in % | Safener | g of ai/ha | safener in % | in % |
| Corn | A-0 | 6.25 | 20 | benoxacor | 200 | 10 | 50 |
| Corn | A-0 | 25 | 50 | isoxadifenethyl | 200 | 30 | 40 |
| Corn | A-0 | 25 | 50 | cyprosulfamide | 200 | 20 | 60 |
| Corn | A-0 | 25 | 50 | furilazole | 200 | 10 | 80 |
| Corn | A-0 | 25 | 50 | cyprosulfamide | 200 | 20 | 60 |
| Corn | A-2 | 6.25 | 40 | isoxadifenethyl | 200 | 10 | 75 |
| Corn | A-2 | 6.25 | 40 | cyprosulfamide | 200 | 10 | 75 |
| Corn | A-2 | 6.25 | 40 | furilazole | 200 | 10 | 75 |
| Corn | A-2 | 6.25 | 40 | fluxofenim | 200 | 0 | 100 |

### b) Pre-Emergence Results

TABLE 4
Corn

| | | Amount of active | Damage to | | Amount of | Damage in the | Reduction of |
|---|---|---|---|---|---|---|---|
| | Active | compound | the crop plant | | safener | presence of the | the damage |
| Crop plant | compound | g of ai/ha | in % | Safener | g of ai/ha | safener in % | in % |
| Corn | A-0 | 50 | 60 | cyprosulfamide | 200 | 40 | 33 |
| Corn | A-0 | 50 | 60 | furilazole | 200 | 40 | 33 |
| Corn | A-2 | 6.25 | 40 | benoxacor | 200 | 20 | 50 |
| Corn | A-2 | 6.25 | 40 | cyprosulfamide | 200 | 20 | 50 |
| Corn | A-2 | 6.25 | 40 | furilazole | 200 | 15 | 63 |
| Corn | A-0 | 12.5 | 65 | furilazole | 200 | 40 | 38 |

1. A herbicide/safener combination comprising
(A) at least one or more herbicide selected from the group consisting of 2-iodo-N-[(4-methoxy-6-methyl-1,3,5-triazin-2-yl)carbamoyl]benzenesulfonamide and compounds of formula (I) 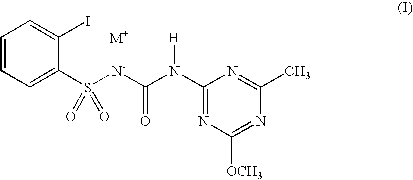
where
the cation (M⁺) is
(a) an alkali metal ion, or
(b) an alkaline earth metal ion, or
(c) a transition metal ion, or
(d) an ammonium ion where optionally one, two or three or all four hydrogen atoms are substituted by identical or different radicals from the group consisting of (C₁-C₄)-alkyl, hydroxy-(C₁-C₄)-alkyl, (C₁-C₆)-cycloalkyl, (C₁-C₄)-alkoxy-(C₁-C₄)-alkyl, hydroxy-(C₁-C₄)-alkoxy-(C₁-C₄)-alkyl, (C₁-C₆)-mercaptoalkyl, phenyl and benzyl,
where the radicals mentioned above are optionally substituted by at least one identical or different radicals selected from the group consisting of halogen, nitro, cyano, azido, (C₁-C₆)-alkyl, (C₁-C₆)-haloalkyl, (C₃-C₆)-cycloalkyl, (C₁-C₆)-alkoxy, (C₁-C₆)-haloalkoxy and phenyl and where in each case two substituents at the nitrogen atom together optionally form an unsubstituted or substituted ring, or
(e) a phosphonium ion, or
(f) a sulfonium ion, or
(g) an oxonium ion, or
(h) a saturated or unsaturated/aromatic nitrogenous heterocyclic ionic compound which has 1-10 carbon atoms in the ring system and is optionally mono- or polycondensed and/or substituted by (C₁-C₄)-alkyl, and
(B) at least one or more safener.

2. The herbicide/safener combination as claimed in claim 1 in which the compound herbicide (A) is 2-iodo-N-[(4-methoxy-6-methyl-1,3,5-triazin-2-yl)carbamoyl]benzenesulfonamide or a compound of the formula (I) in which the cation (M⁺) is
a sodium ion, a potassium ion, a lithium ion, a magnesium ion, a calcium ion, an NH₄⁺ ion, a (2-hydroxyeth-1-yl)ammonium ion, a bis-N,N-(2-hydroxyeth-1-yl)ammonium ion, a tris-N,N,N-(2-hydroxyeth-1-yl)ammonium ion, a methylammonium ion, a dimethylammonium ion, a trimethylammonium ion, a tetramethylammonium ion, an ethylammonium ion, a diethylammonium ion, a triethylammonium ion, a tetraethylammonium ion, an isopropylammonium ion, a diisopropylammonium ion, a tetrapropylammonium ion, a tetrabutylammonium ion, a 2-(2-hydroxyeth-1-oxy)eth-1-ylammonium ion, a di(2-hydroxyeth-1-yl)ammonium ion, a trimethylbenzylammonium ion, a tri-((C₁-C₄)-alkyl)sulfonium ion, or a tri((C₁-C₄)-alkyl)oxonium ion, a benzylammonium ion, a 1-phenylethylammonium ion, a 2-phenylethylammonium ion, a diisopropylethylammonium ion, a pyridinium ion, a piperidinium ion, an imidazolium ion, a morpholinium ion, and/or a 1,8-diazabicyclo[5.4.0]undec-7-enium ion.

3. The herbicide/safener combination as claimed in claim 1 in which the safener is selected from the group consisting of:
the compounds S1-1 (=mefenpyr-diethyl), S1-9 (isoxadifen-ethyl), S2-1 (=chloquintocet-mexyl) and S3-1 (=cyprosulfamide).

4. The herbicide/safener combination as claimed in claim 1, additionally comprising at least one further agrochemically active compound and/or formulation auxiliary and/or additive customary in crop protection.

5. The herbicide/safener combination as claimed in claim 4 where the additional further agrochemically active compound is a herbicide.

6. A method for controlling unwanted vegetation, which comprises applying the components (A) and (B) of the herbicide/safener combination as claimed in claim 1 together or separately, optionally onto plants, an seed and/or the area where plants grow.

7. The method as claimed in claim 6 wherein the method is utilized in crop plants selected from the group consistently of arable crops, vegetable crops, permanent crops and plantation crops.

8. The method as claimed in claim 6 wherein the crop plants are transgenic and/or are tolerant owing to selective breeding.

9. A herbicide, safener combination as defined in claim 1 for controlling harmful plants.

10. A combination of claim 9, which is capable of being used in crop plants.

11. A method of claim 7, wherein the crop plants are transgenic and/or are tolerant owing to selective breeding.

12. A combination of claim 2, further comprising at least one further agrochemically active compound, and/or formulator auxiliary and/or additive customary in crop protection.

13. A combination of claim 3, further comprising at least one further agrochemically active compound, and/or formulator auxiliary and/or additive customary in crop protection.
